(19) United States
(12) Patent Application Publication
(10) Pub. No.: US 2015/0363422 A1
(43) Pub. Date: Dec. 17, 2015

(54) RESOURCE MANAGEMENT SYSTEM AND RESOURCE MANAGEMENT METHOD

(71) Applicant: Hitachi, Ltd., Tokyo (JP)

(72) Inventors: Tsukasa SHIBAYAMA, Kawasaki-shi (JP); Wataru OKADA, Yokohama-shi (JP)

(21) Appl. No.: 13/811,853

(22) PCT Filed: Jan. 10, 2013
(86) PCT No.: PCT/JP2013/000064

§ 371 Date: Jan. 23, 2013

(51) Int. Cl. G06F 17/30; H04L 29/08

(52) U.S. Cl. CPC G06F 17/30203; G06F 17/30079; H04L 67/1097

(57) ABSTRACT

If resources are allocated without considering physical layouts of virtualized physical resources, resources may be physically allocated astride logical partitions, so that a single physical failure may affect multiple logical partitions. Further, if a computer system that does not have a logical partition creation function is replaced with a computer having the logical partition creation function, it may not be possible to maintain the availability prior to migration if logical partitions are created without considering the physical configuration that had been considered prior to replacement. The present invention provides a method for retaining conditions to be ensured for guaranteeing availability of a storage subsystem and a host computer and amount of resources that can be used for creating logical partitions of the storage node when migrating a whole system from the storage subsystem to the storage node, computing a method for creating the logical partitions capable of maximizing the number of conditions that can be ensured for guaranteeing the availability within the range of the amount of resources, and presenting the maximum number of conditions (value of availability that the system has) and the method for creating logical partitions to the user.

### TECHNICAL FIELD

The present invention relates to a resource management system and a resource management method, and specifically, relates to a resource management system and a resource management method of a computer system utilizing a virtualization technique.

### BACKGROUND ART

In a computer system adopting a virtualization technique, one or more virtual machines (hereinafter also referred to as VMs) are activated by executing a virtualization program via the computer. Through use of virtualization techniques, it becomes possible to aggregate multiple servers and to realize enhancement of resource utilization efficiency.

In a prior art computer system, multiple server computers capable of activating one or more VMs are connected to a shared storage subsystem, wherein a hypervisor (program) operating in each server computer manages multiple volumes configured in the shared storage system as storage pools. The hypervisor cuts out necessary capacities from the storage pools and allocates the same to VMs, to thereby realize VM provisioning.

Conventionally, such VM provisioning has been applied to VMs activating business applications. However, patent literature 1 discloses a technique for utilizing a virtualization program in a control module of a storage subsystem to thereby activate multiple versions of storage control programs in a single control module. Further, patent literature 2 discloses an art of creating logical partitions by logically partitioning physical hardware resources retained by the computer, such as interfaces, control processors, memories and disk drives, and the hypervisor within the computer activates storage control programs in the respective logical partitions so as to operate a single storage subsystem as two or more virtual storage subsystems. By applying the techniques disclosed in patent literatures 1 and 2, it becomes possible to operate a single computer virtually as multiple storage subsystems or servers.

### CITATION LIST

### Patent Literature

PTL 1: US Patent Application Publication No. 2008/0243947

PTL 2: Japanese Patent Application Laid-Open Publication No. 2005-128733 (U.S. Pat. No. 7,127,585)

### SUMMARY OF INVENTION

### Technical Problem

Conventionally, in order to activate a single computer virtually as multiple storage subsystems or servers, the physical resources are virtualized with the aim to enhance resource utilization efficiency. However, when partitioning the virtualized physical resources and allocating the same to logical partitions, if the resources are allocated without considering the physical layout of the virtualized physical resources, there may be cases where resources are physically allocated astride logical partitions. In such case, a single physical failure may affect multiple logical partitions, causing a problem.

Moreover, in order to perform replacement from a computer system that does not have a logical partition creation function to a computer having a logical partition creation function, when the logical partitions are created without considering the physical configuration that had been considered before replacement (such as the primary volume and the secondary volume using the copy function of the storage subsystem utilizing parity groups created from different physical disks, or the CPU and the memory being physically partitioned in a cluster-configuration system), it may be possible that the availability prior to migration (such as the standby system being activated immediately when failure occurs) cannot be maintained, causing a problem.

Even further, when the logical partitions are designed considering availability, there is a drawback that it is difficult to recognize an appropriate method for designing logical partitions capable of satisfying the availability of the computer system prior to migration using limited resources after migration.

In consideration of the above drawbacks of the prior art, the present invention provides, in a computer capable of being operated virtually as one or more storage subsystems or servers, a method for creating logical partitions and a method for setting a storage configuration capable of maximizing the availability using limited resources while considering the layout of virtualized physical resources based on availability requirements of the system requested by the user when creating the logical partitions.

### Solution to Problem

In order to solve the problems mentioned above, the present invention provides a computer system including a storage subsystem and a storage node connected to a host computer via a network, and a storage management computer capable of accessing the same, wherein the system comprises a function to create logical partitions by virtually partitioning processors, memories and disks and allocating the partitioned resources. During migration of the overall system from the storage subsystem to the storage node, the storage management computer retains conditions to be ensured for guaranteeing availability of the storage subsystem and the host computer, and the amount of resource that can be used for creating logical partitions of the storage node. Then, a method for creating logical partitions capable of maximizing the number of conditions capable of being ensured within the range of the amount of resources is computed, and the maximum number of conditions (value of availability that the system has) and the method for creating logical partitions are presented to the user.

### Advantageous Effects of Invention

In a computer capable of being operated virtually as one or more storage subsystems or servers, the present invention enables to present a method for creating logical partitions and a method for setting storage configuration capable of maximizing availability using limited resources based on the requirements of availability of the system requested by the user. Thereby, the user introducing the computer can cut down costs related to designing a virtual storage subsystem or creating a virtual server having high availability.

### BRIEF DESCRIPTION OF DRAWINGS

FIG. 1 is a configuration diagram of a computer system according to embodiment 1.

FIG. 2 is a configuration diagram of a host computer according to embodiment 1.

FIG. 3 is a configuration diagram of a file storage according to embodiment 1.

FIG. 4 is a configuration diagram of a block storage according to embodiment 1.

FIG. 5 is a configuration diagram of a physical side view of a storage node of embodiment 1.

FIG. 6 is a configuration diagram of a logical side view of the storage node of embodiment 1.

FIG. 7 is a view showing the details inside a memory within the storage node according to embodiment 1.

FIG. 8 is a configuration diagram of a management server according to embodiment 1.

FIG. 9 is a view showing information of a file configuration management table according to embodiment 1.

FIG. 10 is a view showing information of a block configuration management table according to embodiment 1.

FIG. 11 is a view showing information of a block PP management table according to embodiment 1.

FIG. 12 is a view showing information of a storage node-side physical resource management table according to embodiment 1.

FIG. 13 is a view showing information of a storage node-side logical partition configuration management table according to embodiment 1.

FIG. 14 is a view showing information of a management-side physical resource management table according to embodiment 1.

FIG. 15 is a view showing information of a management-side logical partition configuration management table according to embodiment 1.

FIG. 16 is a view showing information of a migration source configuration management table according to embodiment 1.

FIG. 17 is a view showing information of a migration source PP management table according to embodiment 1.

FIG. 18 is a view showing information of a logical partition creation request management table according to embodiment 1.

FIG. 19 is a view showing a flowchart of the overall process according to embodiment 1.

FIG. 20 is a view showing a flowchart of the process for acquiring configuration information of the computer prior to migration according to embodiment 1.

FIG. 21 is a flowchart of the process for creating a logical partition creation request based on the configuration information of the computer prior to migration according to embodiment 1.

FIG. 22 is a (partial) flowchart of the process for computing a configuration where the availability becomes maximum from logical partitions satisfying all logical partition creation requests according to embodiment 1.

FIG. 23 is a (partial) flowchart of the process for computing a configuration where the availability becomes maximum from logical partitions satisfying all logical partition creation requests according to embodiment 1.

FIG. 24 is a (partial) flowchart of the process for creating logical partitions and storage configuration according to embodiment 1.

FIG. 25 is a (partial) flowchart of the process for creating logical partitions and storage configuration according to embodiment 1.

FIG. 26 is a (partial) flowchart of the process for creating logical partitions and storage configuration according to embodiment 1.

FIG. 27 is a view showing one example of a GUI for performing configuration information change according to a modified example of embodiment 1.

FIG. 28 is a view showing a flowchart of the process for acquiring and updating configuration information of a computer prior to migration according to the modified example of embodiment 1.

FIG. 29 is a view showing a flowchart of the process for deleting logical partitions according to embodiment 2.

FIG. 30 is a view showing a flowchart of the process for acquiring and updating the configuration information of the computer prior to migration according to embodiment 2.

FIG. 31 is a view showing a detailed view within a memory of a management server according to embodiment 3.

FIG. 32 is a view showing information of a save data management table according to embodiment 3.

FIG. 33 is a view showing a flowchart of the overall processing of embodiment 3.

FIG. 34 is a view showing a flowchart of the process for saving data in a virtual storage system within a storage node according to embodiment 3.

FIG. 35 is a view showing a flowchart of the process for returning the saved data according to embodiment 3.

FIG. 36 is a view showing a flowchart of the overall processing of embodiment 4.

FIG. 37 is a view showing one example of a GUI for entering and editing conditions of configuration information according to embodiment 4.

FIG. 38 is a view showing a flowchart of the process for entering conditions of configuration information according to embodiment 4.

### DESCRIPTION OF EMBODIMENTS

Now, the preferred embodiments of the present invention will be described with reference to the drawings. The following embodiments of the present invention are mere examples for realizing the present invention, and are not intended to limit the technical scope of the present invention in any way. In the following description, various information are referred to as “tables”, “lists”, “DBs”, “queues” and the like, but the various information can be expressed by data structures other than tables, lists, DBs and queues. Further, the “tables”, “lists”, “DBs”, “queues” and the like can also be referred to as “information” to indicate that the information does not depend on the data structure. Further, the contents of the information may be referred to as “identification information”, “identifier”, “name” and “ID”, but they are mutually replaceable. Moreover, the term “information” or other expressions can be used to refer the data contents.

The processes are sometimes described using the term “program” as the subject, but the program is executed by a processor performing determined processes using the memories and communication ports (communication control units), so that a processor can also be used as the subject of the processes. The processes described using the term program as the subject can be the processes performed via computers and information processing devices such as management servers or storage systems. A portion or all of the programs can be realized via a dedicated hardware. The various programs can be provided via a program distribution server or a storage media to the various computers, for example.

### Embodiment 1

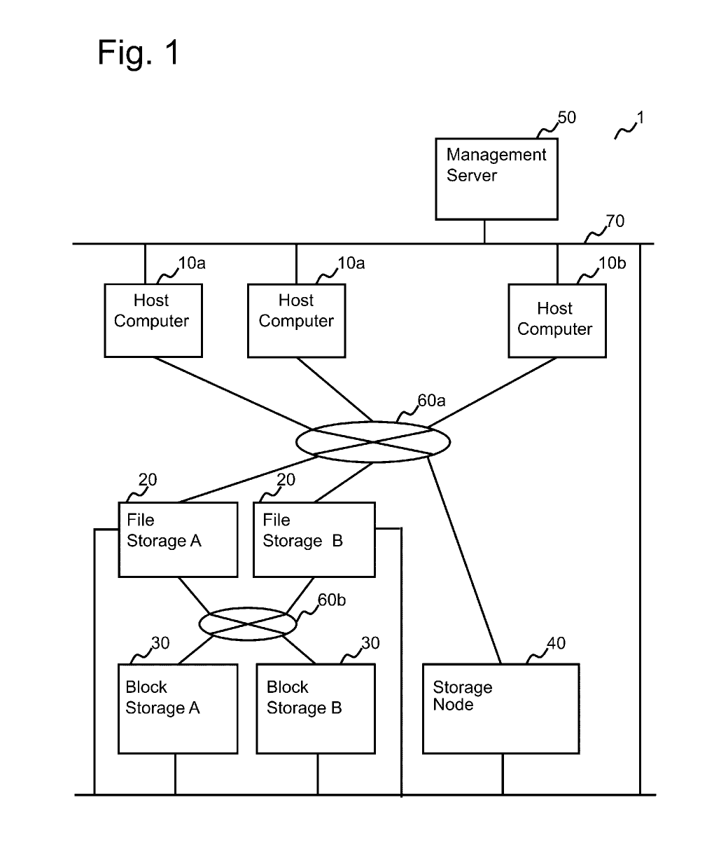

FIG. 1 is a block diagram illustrating a configuration example of a computer system according to the present embodiment. A computer system 1 according to the present embodiment includes host computers 10a and 10b, file storages 20, block storages 30, a storage node 40, a management server 50, data networks 60a and 60b, and a management network 70. The host computers 10a are coupled to the file storage via the data network 60a. The file storage 20 and the block storage 30 are coupled via the data network 60b. The host computer 10b is coupled to the storage node 40 via the data network 60a. The host computers 10a and 10b, the file storage 20, the block storage 30, the storage node 40 and the management server 50 are coupled via the management network 70. The data networks 60a and 60b do not have to be separate networks, and can be constituted as a single network. Moreover, the protocols of the data network 60 and the management network 70 can adopt arbitrary protocols such as FC (Fibre Channel) and IP (Internet Protocol), and further, the data network 60 and the management network 70 can be constituted as a single network.

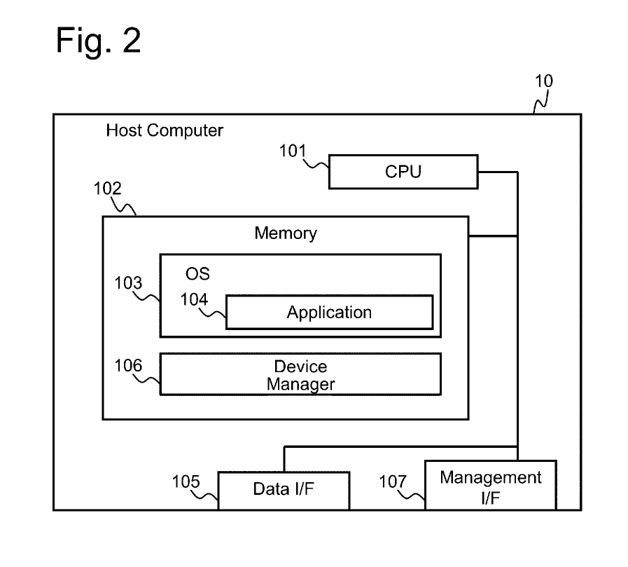

FIG. 2 is a view showing an example of the host computer 10. The host computer 10 includes a CPU 101, a memory 102, a data interface 105, and a management interface 107. The memory 102 includes an OS (Operating System) 103 and a device manager 106 mounting a storage area of a storage subsystem. The memory 102 includes an application 104. The CPU 101 operates the OS 103, the device manager 106 and the application 104 in the memory. The data interface 105 is coupled to the data network 60. The management interface 107 is coupled to the management network 70. Further, the data interface 105 and the management interface 107 can be the same.

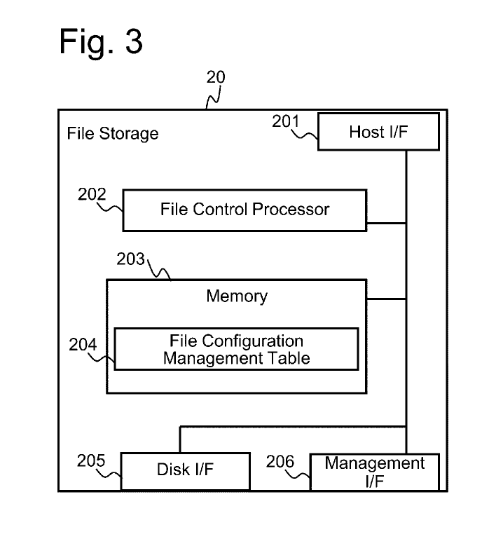

FIG. 3 is a view showing an example of the file storage 20. The file storage 20 includes a file control processor 202, a memory 203, a host interface 201, a disk interface 205, and a management interface 206. Further, the memory 203 includes a file configuration management table 204. The host interface 201 is coupled to the host computer 10 via the data network 60a. The disk interface 205 is coupled to the block storage 30 via the data network 60b. The management interface 206 is coupled to the management server 50 via the management network 70. The file control processor 202 mounts a volume of the block storage 30, and operates the file storage 20 as a NAS (Network Attached Storage). Here, the description of the detailed operation of the NAS will be omitted. The file configuration management table 204 within the memory 203 stores physical resource information that the file storage 20 has. The file configuration management table will be described in detail later.

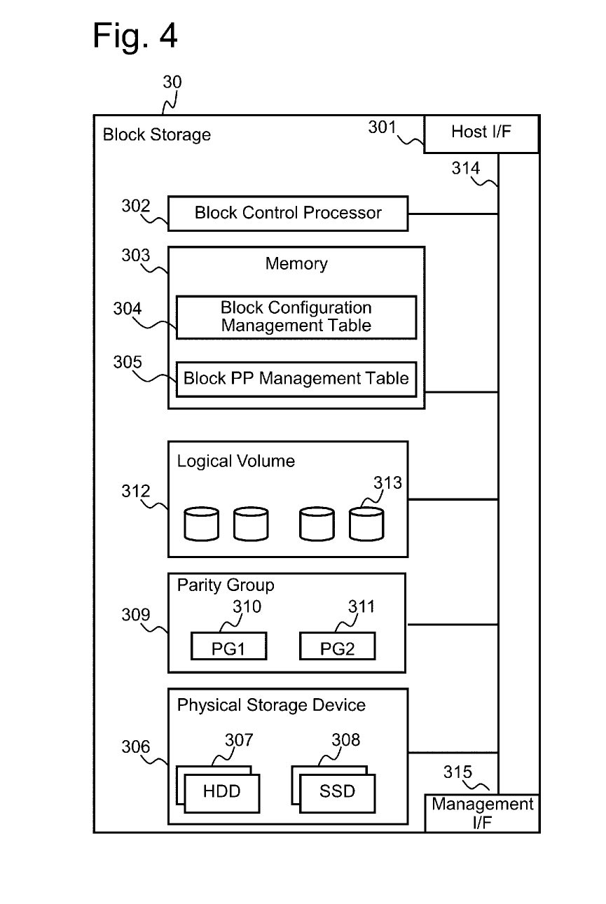

FIG. 4 is a view showing an example of the block storage 30. The block storage 30 includes a block control processor 302, a memory 303, a physical storage device 306, a parity group 309, a logical volume 312, a host interface 301, and a management interface 315. The memory 303 stores a block configuration management table 304 and block PP management table 305. The block configuration management table 304 and the block PP management table 305 will be described in detail later. The physical storage device 306 includes multiple types of physical storage areas, such as one or more HDDs (Hard Disk Drives) 307 and one or more SSDs (Solid State Drives) 308. Further, the varieties of the physical storage devices can be any arbitrary type of devices other than HDDs and SSDs. The parity group 309 is composed of multiple physical storage devices. As shown in FIG. 4, multiple parity groups 310 and 311 are created.

The logical volume 312 is a logical storage area created from parity groups, which can be used as storage areas by being allocated to host computers 10 and file storages 20. One or more logical volumes 313 are created. Generally, when data copy is performed in a single storage subsystem with the aim to acquire backup of a logical volume 313, data copy is performed between two logical volumes in physically separated different parity groups. This is performed with the aim to enhance usability by preventing the logical volume used during normal use and the backup volume from not being able to be used simultaneously due to physical failure of the disk. The host interface 301 is coupled to the host computer 10 and the block storage 30 via the data network 60. The management interface 315 is coupled to the management server 50 via the management network 70.

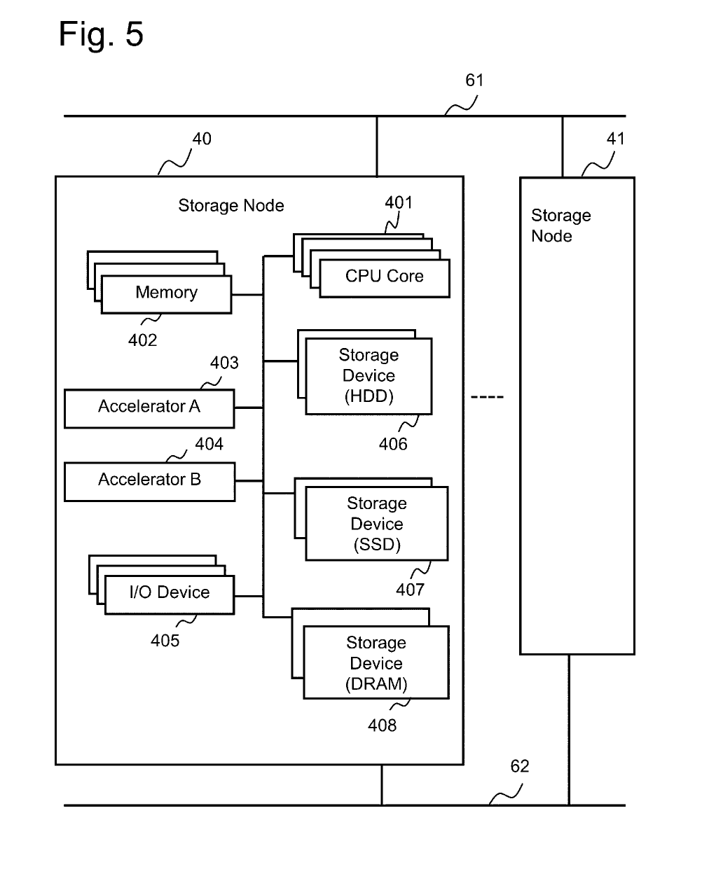

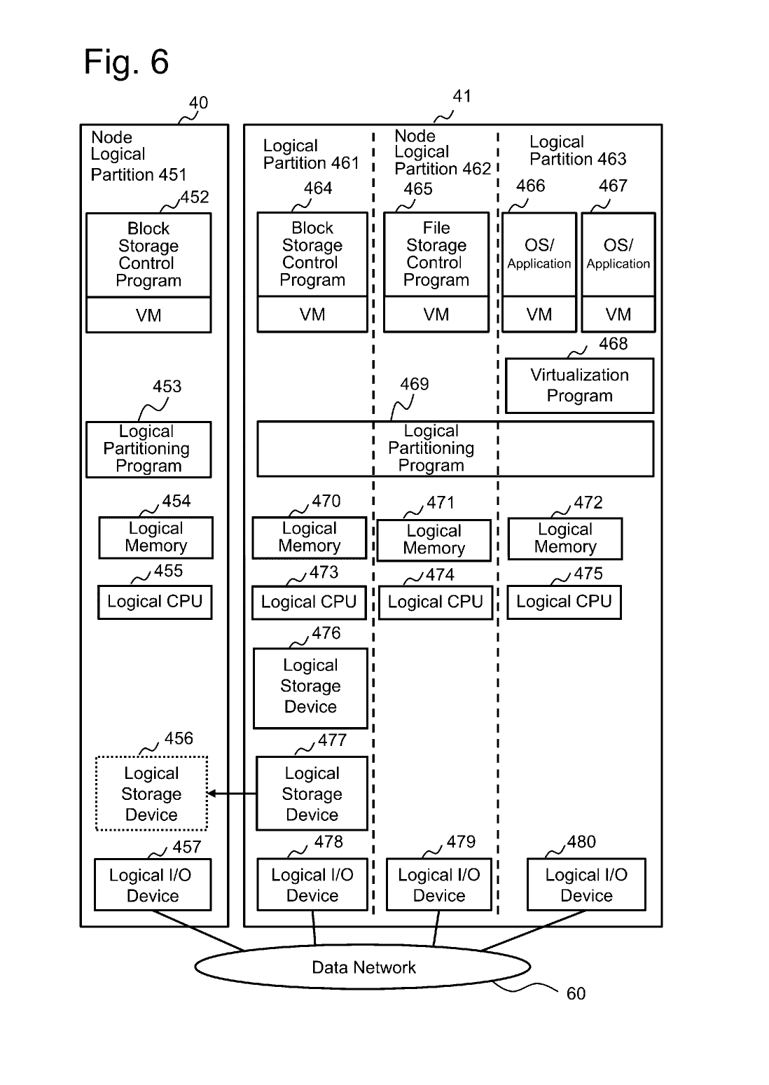

FIGS. 5 and 6 are views showing an example of the storage node 40 (hereafter, the storage node may be simply referred to as node). The storage node 40 is a device capable of operating multiple virtual storage subsystems and virtual servers by logically partitioning the space within the node and creating multiple logical partitions. FIG. 5 illustrates a physical side view of the storage node 40, and FIG. 6 illustrates a block diagram illustrating in frame format the logical side view of the storage node 40.

As shown in FIG. 5, the storage node 40 is a unit component (device) within the system managed by the management server 50, which includes one or more types of physical devices (CPUs, memories, storage devices, I/O devices and the like). Typically, the component devices constituting the storage node is stored in a single casing, but the storage node can also adopt other configurations. FIG. 5 illustrates two nodes, a storage node 40 and a storage node 41. The storage nodes 40 and 41 are coupled in a manner enabling communication via internal connection protocol of the node (PCI, PCIe, SCSI, InfiniBand and the like) via a network 62. The storage nodes 40 and 41 are coupled in a manner enabling communication via a network 61 such as a FC (Fibre Channel), Ethernet (Registered Trademark) or FCoE (Fibre Channel over Ethernet). Mutual communications via the networks 61 and 62 are included in the communication realized via the network 60 illustrated in FIG. 1.

The respective nodes 40 and 41 are equipped with multiple types of physical devices. In the example of FIG. 5, the node 40 includes a CPU including multiple CPU cores 401, multiple memories (such as memory chips or memory boards) 402, multiple HDDs 406, multiple SSDs 407, multiple DRAM drives 408, an accelerator A 403, an accelerator B 404, and multiple I/O devices 405. The HDDs 406, the SSDs 407 and the DRAM drives 408 are secondary storage devices.

The CPU cores 401 execute programs stored in memories 402. The functions provided to the node 40 can be realized by CPU cores 401 executing given programs. The memories 402 store programs being executed by CPU cores 401 and the necessary information for executing the programs. If the node functions as a storage subsystem, the memories 402 can function as cache memories (buffer memories) of user data.

Storage devices 406, 407 and 408 are direct access storage devices (DAS), which is capable of storing data used by programs or the user data in a node functioning as a storage subsystem.

I/O devices 405 are devices for connecting to external devices (such as other nodes or a management server computer 50), examples of which are an NIC (Network Interface Card), an HBA (Host Bus Adaptor), or a CNA (Converged Network Adapter). The I/O devices 405 include one or more ports.

FIG. 6 illustrates a logical configuration example of a node in frame format. In FIG. 6, two nodes are illustrated. Each node provides a virtualization environment for operating a virtual machine (VM).

Actually, in node 40, the CPU (CPU core) executes a logical partitioning program 453 using a memory, and the logical partitioning program 453 logically partitions a physical resource of the node 40 to create one or more logical partitions within the node 40, and manages the logical partitions. In the present example, a single logical partition 451 is created.

The logical partition refers to a logical section created by logically partitioning a physical resource provided in the node. Each logical partition can have a partitioned physical resource constantly allocated as a dedicated resource. In that case, a resource is not shared among multiple logical partitions. Thus, the resource of the relevant logical partition can be guaranteed. For example, by allocating a storage device as a dedicated resource to a certain logical partition, it becomes possible to eliminate access competitions from other logical partitions to the storage device and to ensure performance. Further, the influence of failure of the storage device can be restricted to the corresponding logical partition allocated thereto. However, it is also possible to share resources among multiple logical partitions.

For example, it is possible to flexibly utilize resources such as CPUs and networks among logical partitions and to efficiently utilize resources. Of course, it is possible to adopt a configuration where the CPUs are shared among multiple partitions, but the memories and storage devices are used exclusively by each logical partition. The logical partitioning program can use a logical partitioning function that the physical device has, and recognizes the partitioned section as a single physical device. The physical resource being allocated is called a logical hardware resource (logical device).

The method for logically partitioning multiple CPU cores arranged on a single chip or being connected via a bus and allocating the same to logical partitions can be performed, for example, by allocating each CPU core respectively to a single logical partition. Each CPU core is used exclusively by the logical partition to which the core is allocated, and the CPU core having been allocated constitutes a logical CPU (logical device) of the relevant logical partition.

A method for logically partitioning one or more memories (physical devices) and allocating the same to logical partitions is performed, for example, by allocating each of multiple address areas in a memory area respectively to a single logical partition. The allocated area is the logical memory (logical device) of the relevant logical partition.

The method for logically partitioning one or more storage devices (physical devices) and allocating the same to logical partitions is performed, for example, by allocating a storage drive, a storage chip on a storage drive, or a given address area to any single logical partition. The allocated dedicated physical device element is the single logical storage device corresponding to the relevant logical partition.

The method for logically partitioning one or more I/O devices (physical devices) allocates, for example, each I/O board or each physical port to any single logical partition. The allocated dedicated physical device element is the single logical I/O device of the relevant logical partition. In the logical partition, the program can access a physical I/O device or a physical storage device without passing through an emulator (pass-through).

In the logical partition 451, the CPU core having been allocated (logical CPU) executes a block storage control program using the allocated memory (logical memory), and functions as a virtual machine 452 of a block storage controller (virtual block storage controller). The logical partition 451 in which the block storage control program is operated functions as a virtual block storage subsystem.

The virtual block storage controller 452 can directly access a logical storage device 477 of a different node 41 (external connection function), so that when failure occurs in node 41, the data stored in the logical storage device 477 can be taken over (sharing of storage device).

Thus, the physical resource allocated to the logical partition can include a logical device of a different node if the device can be accessed directly in the node. The virtual block storage controller 452 connects to the data network 60 via a logical I/O device 457, and can communicate with other nodes.

In FIG. 6, a logical partitioning program 469 is operated in a node 41 (executed via a CPU using a memory), by which logical partition 461, 462 and 463 are created and managed. Partitioned physical resources of the node 41 are respectively directly allocated to the logical partitions 461, 462 and 463.

In the logical partition 461, a block storage control program is operated in the allocated logical CPU core 473, and the program functions as a virtual machine of the block storage controller (virtual block storage controller) 464. The logical partition 461 in which the block storage control program operates functions as a virtual block storage subsystem.

Logical storage devices 476 and 477 are allocated to the logical partition 461. The virtual block storage controller 464 stores the user data of the host in the logical storage devices 476 and 477. As described, the virtual block storage subsystem (logical partition) 461 can utilize a portion of the physical area of the logical memory 470 allocated to the logical partition 461 as cache (buffer) of the user data.

The virtual block storage controller 464 connects to the data network 60 via a logical I/O device 478 allocated to the logical partition 461, and can communicate with host computers or other nodes functioning as the storage subsystem.

In the logical partition 462, a file storage control program is operated, and the program functions as a virtual machine 465 of a file storage controller (virtual file storage controller). The virtual file storage controller 465 accesses the virtual block storage subsystem 461 within the same node 41, for example, stores the file including the user data of the host in the logical storage devices 476 and 477, and manages the same. The virtual file storage controller 465 connects to the data network 60 via a logical I/O device 479 allocated to the logical partition 462, and can communicate with other nodes.

In the logical partition 463, a virtualization program 468 is operated in the allocated logical CPU 475. The virtualization program 468 creates one or more VMs, activates the created VMs and controls the same. In the present example, two VMs 466 and 467 (operation VMs) are created and operated. Each VM 466 and 467 executes an operating system (OS) and an application program.

The virtualization program 468 has an I/O emulator function, and the VMs 466 and 467 can access other virtual machines within the same node via the virtualization program 468. Moreover, the VMs can access other nodes via the virtualization program 468, the logical I/O device 480 and the data network 60. For example, VMs 466 and 467 are hosts accessing the virtual file storage subsystem 462. The operation VM can also be operated within the logical partition without utilizing the virtualization program 468.

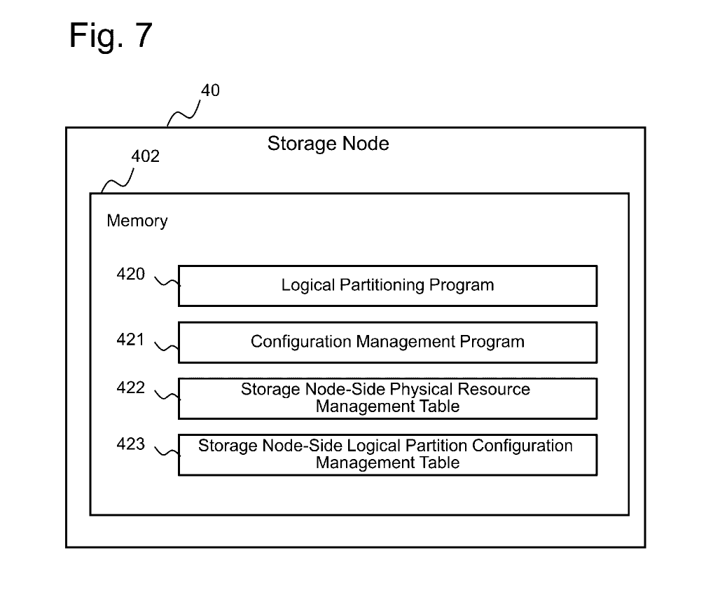

FIG. 7 is a description of tables and programs included in a memory 402 within the storage node 40. The memory 402 includes a logical partitioning program 420, a configuration management program 421, a storage node-side physical resource management table 422 and a storage node-side logical partition configuration management table 423. The logical partitioning program 420 is the same as logical partitioning programs 453 and 469 of FIG. 6. The configuration management program 421 is a program for managing the configuration information of the storage node 40. The storage node-side physical resource management table 422 and the storage node-side logical partition configuration management table 423 are each a table for storing physical resource information within the storage node and a table for storing information of a physical resource constituting the logical partition within the storage node. The details thereof will be described later.

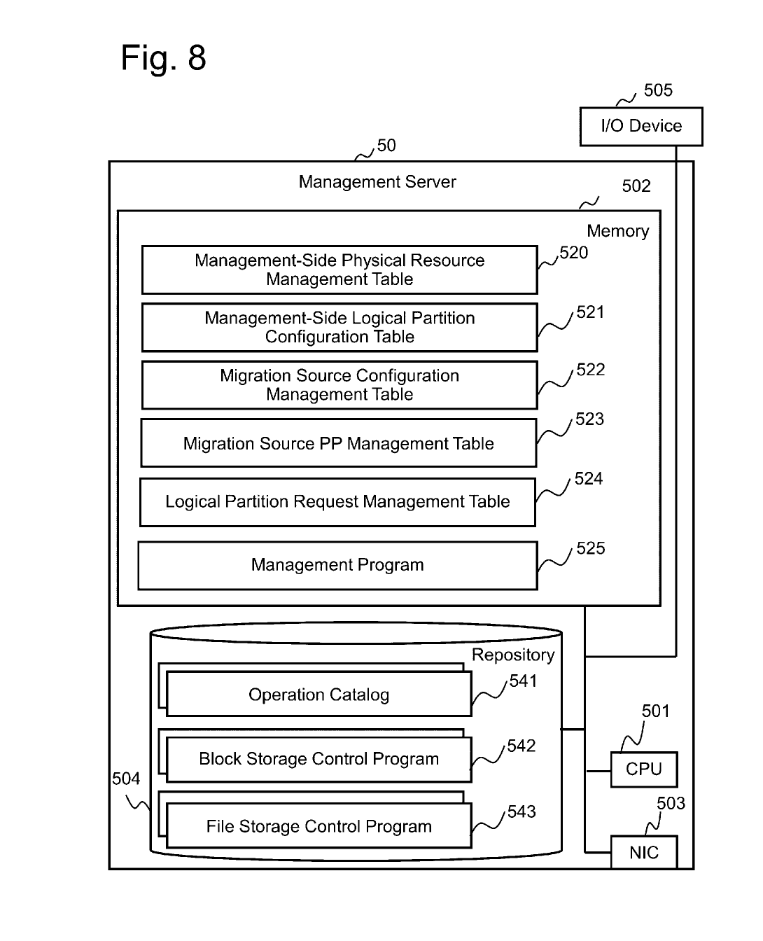

FIG. 8 is a block diagram illustrating an example of the management server 50. The management server 50 manages the whole present computer system. The management server 50 is connected via the management network 70 with the host computer 10, the file storage 20, the block storage 30 and the storage node 40, and can acquire necessary information from the respective computers via the management network 70, or can provide necessary information (including programs) to the respective computers.

The management server 50 includes a CPU 501 which is a processor, a memory 502, an NIC 503, a repository 504 and an input and output device 505. The CPU 501 executes programs stored in the memory 502. By the CPU 501 executing given programs, the functions provided to the management server 50 can be realized, and the CPU 501 functions as a management unit by being operated via a management program 525. The management server 50 is a device including a management unit.

The memory 502 stores programs executed via the CPU 501 and necessary information for realizing the programs. Actually, the memory 502 stores a management-side physical resource management table 520, a management-side logical partition configuration table 521, a migration source configuration management table 522, a migration source PP management table 523, a logical partition creation request management table 524 and a management program 525. Other programs can also be stored.

For sake of better understanding, the respective programs and tables are illustrated to be included in the memory 502 as main memory, but typically, the respective programs and tables are loaded to the storage area of the memory 502 from storage areas of secondary storage devices (not shown in the drawing). Secondary storage devices are for storing necessary programs and data for realizing given functions, which are devices having nonvolatile, non-temporary storage media. Further, the secondary storage devices can be external storage devices connected via a network.

The management program 525 manages the information of the respective management targets (the host computer 10, the file storage 20, the block storage 30 and the storage node 40) using the information in the management-side physical resource management table 520, the management-side logical partition configuration table 521, the migration source configuration management table 522 and the migration source PP management table 523. The functions realized via the management program 525 can be disposed as management units via hardware, firmware or a combination thereof disposed in the management server 50.

The management-side physical resource management table 520 is a table for storing the information of the physical resource that each management target (the file storage 20, the block storage 30 and the storage node 40) has. The management-side logical partition configuration table 521 is a table illustrating the information on the physical resources constituting the logical partitions of one or more storage nodes being the management target.

The migration source configuration management table 522 is a table indicating the configuration information of a migration source system (the host computer 10, the file storage 20 and the block storage 30) for migrating the migration source system to the storage node 40.

The migration source PP management table 523 is a table showing the information on the PP (Program Product) utilized in the system (the host computer 10, the file storage 20 and the block storage 30) for migrating the migration source system to the storage node 40. The migration source configuration management table 522 and the migration source PP management table 523 include availability conditions that must be ensured in the migration source computer system.

The logical partition creation request management table 524 is a table for managing the contents of request of the logical partitions created in the storage node 40.

The management-side physical resource management table 520, the migration source configuration management table 522, the migration source PP management table 523 and the logical partition creation request management table 524 will be described in detail later.

The NIC 503 is an interface for connecting to the respective management targets (the host computer 10, the file storage 20, the block storage 30 and the storage node 40), and an IP protocol is utilized, for example.

The repository 504 stores multiple operation catalogs 541, multiple block storage control programs 542 and multiple file storage control programs 543. The operation catalog 541 includes programs for realizing operation, and specifically, includes programs for creating operation VMs, such as an operation application program, an operating system or a middleware program. The VMs in which these programs are operated function as the operation VMs.

The block storage control program 542 and the file storage control program 543 are control programs for realizing a virtual block storage subsystem and a virtual file storage subsystem. The repository 504 includes block storage controls programs 542 and file storage control programs 432 of various types and versions. The VM in which these programs are operated function as a virtual storage subsystem.

The management server 50 includes an input and output device 404 for operating the management server 50 connected thereto. The input and output device 505 is a device such as a mouse, a keyboard and a display, which is utilized for input and output of information between the management server computer 50 and the administrator (or user).

The management system of the present configuration example is composed of the management server 50, but the management system can also be composed of multiple computers. The processor of the management system includes multiple CPUs of computers. One of the multiple computers can be a display computer connected via the network, wherein the multiple computers can realize equivalent processes as the management server computer 50 for enhancing the speed and reliability of the management process.

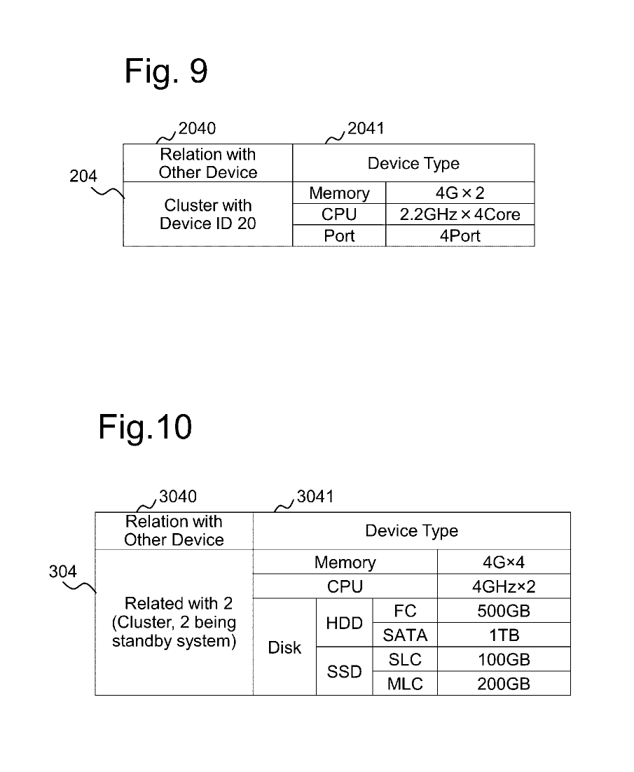

Starting from FIG. 9, the tables stored in the memory of each computer will be described. FIG. 9 illustrates the file configuration management table 204 stored in the memory 202 of the file storage 20. The file configuration management table 204 stores information (2040) and (2041) described below.

(2040) Relation with other devices: The table stores information on the relationship between the present device and other devices. As an example, when the device is in a cluster relationship with file storages of other devices, the information thereof is stored. This information is utilized as the availability condition hereafter.

(2041) Device type: The table stores the types and amounts of physical resources used by the file storage. For example, the tables stores information on the memories, the CPUs, the ports and the like. In FIG. 9, only simple information such as specifications and numbers are shown, but it is also possible to store more detailed information such as the manufacturer information and the reliability (such as MTBF (Mean Time Between Failure)).

FIG. 10 illustrates the block configuration management table 304 stored in the memory 302 of the block storage 30. The block configuration management table 304 stores the following information (3040) and (3041).

(3040) Relation with other devices: The table stores the information on the relationship between the present device and other devices. As an example, when the device is in a cluster relationship with the block storages of other devices, the information thereof is stored. This information is utilized as the availability condition hereafter. (3041) Device type: The table stores the types and amounts of physical resources used by the block storage. For example, the table stores information on the memory, the CPU, the port, the disk and the like. In FIG. 10, only simple information such as specifications and numbers are shown, but it is also possible to store more detailed information such as the manufacturer information and the reliability (such as the MTBF (Mean Time Between Failure)).

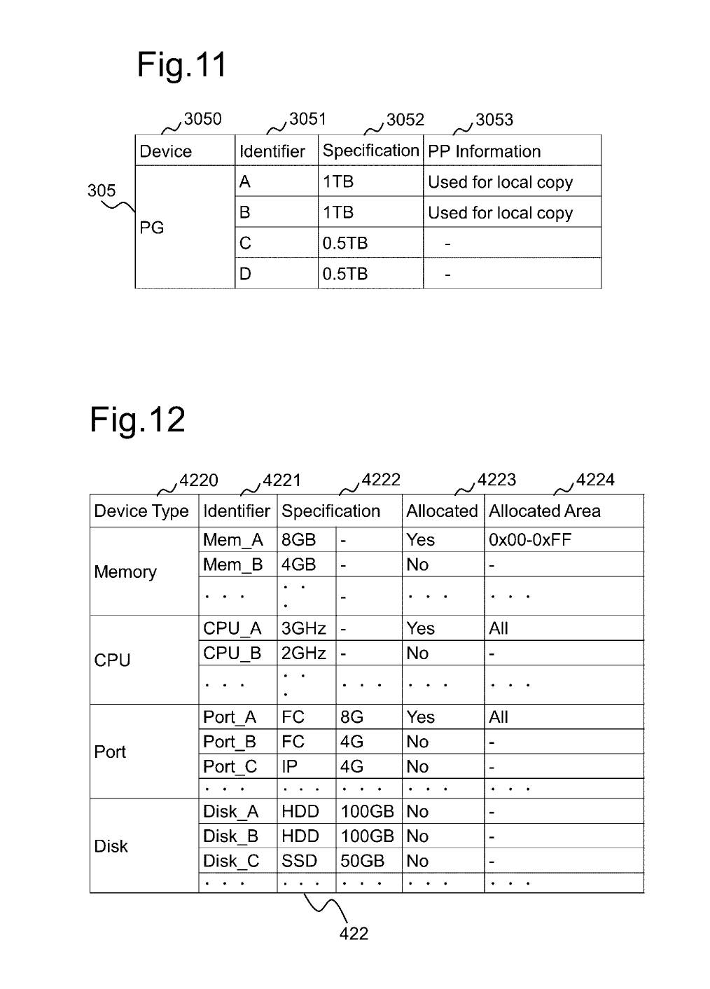

FIG. 11 illustrates the block PP management table 305 stored in the memory 302 of the block storage 30. The block PP management table 305 stores the conditions of the PP to be ensured in the migration source system. The block PP management table 305 stores the following information (3050) through (3053).

(3050) Device type: The table stores the information on the type of the resource that must be ensured by the PP of the block storage. For example, the information of parity groups are stored. The information to be stored here can be an arbitrary resource information retained by the block storage. This information is utilized as the availability condition hereafter.

(3051) Device identifier: The table stores the information for uniquely identifying a device 3050 within the block storage.

(3052) Specification: The table stores the information showing the specification of the device 3050. For example, capacity information of a parity group (PG) is stored herein. Any arbitrary information can be set as long as the information relates to a specification information that must be ensured by the device 3050, such as the response performance and the like.

(3053) PP information: The table stores the PP information utilized in the migration source block storage. This information is one information for determining the condition to be ensured in the migration destination.

FIG. 12 illustrates the storage node-side physical resource management table 422 stored in the memory 402 of the storage node 40. The storage node-side physical resource management table 422 stores the physical resource information that the storage node 40 retains, and whether the physical resource is already allocated to the logical partition or not. The storage node-side physical resource management table 422 stores the following information (4220) through (4224).

(4220) Device type: The table stores the information on the physical device types such as the CPU, the memory, the port and the disk. The information is not restricted thereto, and the physical information of all types of devices included in the storage node can be stored.

(4221) Identifier: The table stores the identifier of the physical resource illustrated in the device type 4220.

(4222) Specification: The table stores the specification information of the physical resources shown via identifier 4221. In FIG. 12, the memory capacity, the CPU frequency, the port type, speed, and the disk type and capacity are shown as an example, but the information is not restricted thereto, and other information such as the memory response performance and the CPU manufacturer or vendor can be set.

(4223) Allocated flag: The table stores the information showing whether the physical resource represented by identifier 4221 is already allocated to the logical partition or not.

(4224) Allocated area: The table stores the information showing which area of the physical resource having the allocated flag 4223 set to yes has already been allocated. In FIG. 12, if all areas are already allocated, All is stored in the table, and if a portion of the areas is already allocated, the memory address is shown in the table, but the expression method is not restricted to this example, and any method can be adopted as long as the already allocated areas can be recognized.

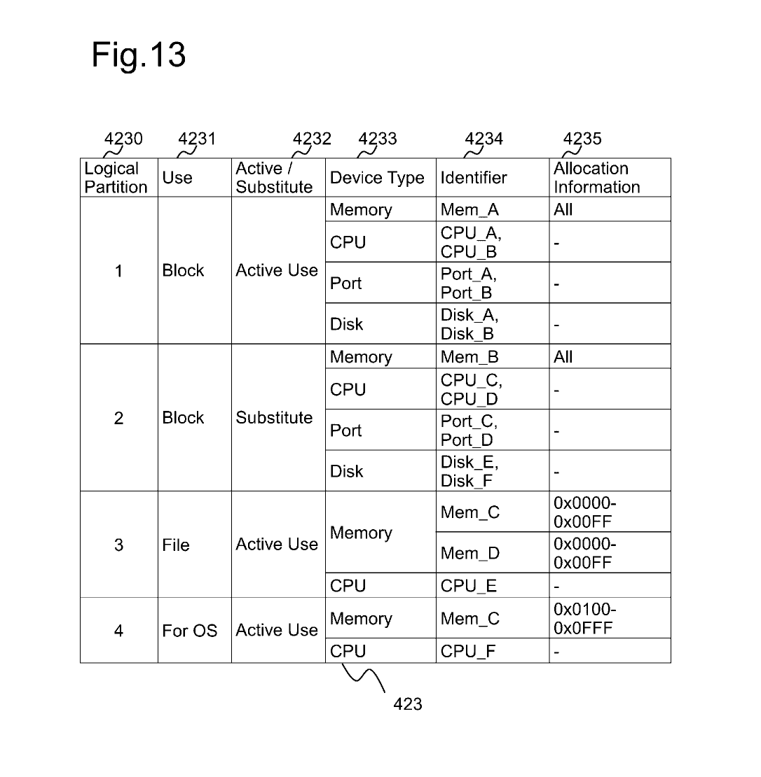

FIG. 13 is a view illustrating the storage node-side logical partition configuration management table 423 stored in the memory 402 of the storage node 40. The storage node-side logical partition configuration management table 423 stores the information on the logical partitions retained by the storage node 40, the purpose of use of the logical partitions, and the physical resource information allocated to the logical partitions. The storage node-side logical partition configuration management table 423 stores the following information (4230) through (4235).

(4230) Logical partition number: The table stores the numbers identifying the logical partitions within the storage node 40.

(4231) Purpose: The table stores the purpose of use of the logical partitions. In FIG. 13, “block” is stored when the partition is used for block storages, “file” is shown when the partition is used for file storages, and “for OS” is stored when the partition is used for common OS, but they can be shown in other ways.

(4232) Active use/substitute flag: The table stores the information on whether the logical partition is used in an actively used system or in a standby system.

(4233) Device type: The table stores the physical device type information such as the CPU, the memory, the port and the disk. Any information can be stored related to the types of physical devices that the storage node retains.

(4234) Identifier: The table stores the identifier of physical resources shown in device type 4233.

(4235) Allocation information: The table stores the information on which area of the physical resource shown by the device type 4233 is allocated to the logical partition 4230. For example, memory (Mem_A) indicates that all the areas are allocated to the logical partition 1, and memory (Mem_C) shows that addresses 0x0000 to 0x00FF are allocated to the logical partition 3. The method for indicating the allocation information is not especially restricted to this method, and any method of statement can be adopted as long as the allocated area can be recognized.

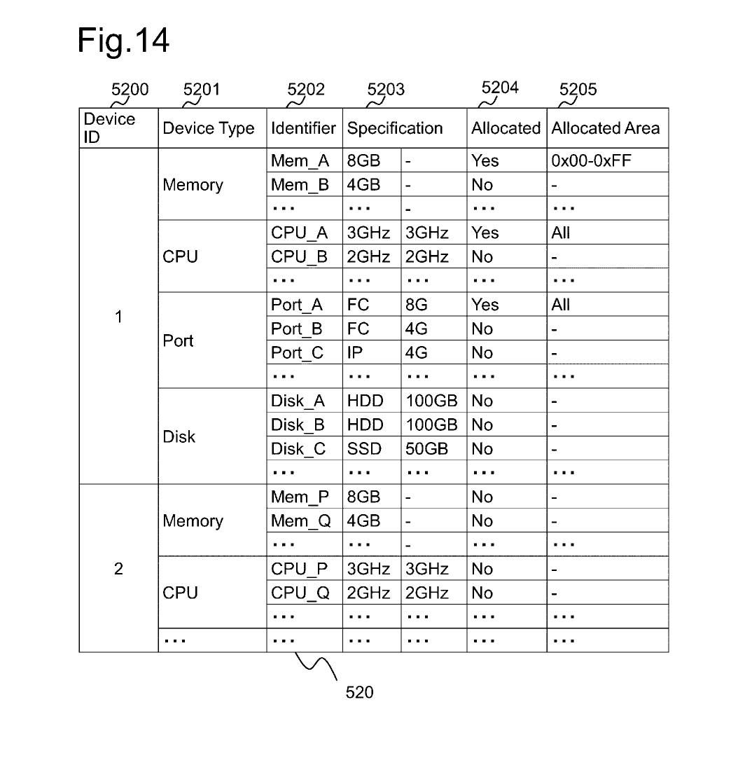

FIG. 14 illustrates the management-side physical resource management table 520 stored in the memory 502 of the management server 50. The management-side physical resource management table 520 gathers information in the storage node-side physical resource management table 422 from multiple storage nodes 40, and assembles the information in a single table. The information other than the identifier information of the device is the same as the storage node-side physical resource management table 422. The management-side physical resource management table 520 stores the following information (5200) through (5205).

(5200) Device ID: The table stores the identifier of the device of the storage node 40.

(5201) Device type: The table stores the physical device type information such as the CPU, the memory, the port and the disk. This information is the same as the device type 4220 of the storage node-side physical resource management table 422.

(5202) Identifier: The table stores the identifier of the physical resource illustrated in the device type 5201. This information is the same as the identifier 4221 of the storage node-side physical resource management table 422.

(5203) Specification: The table stores the specification information of the physical resource shown by identifier 5202. This information is the same as the specification 4222 of the storage node-side physical resource management table 422.

(5204) Allocated flag: The table stores the information showing whether the physical resource shown by identifier 5202 has already been allocated to the logical partition or not. This information is the same as the allocated flag 4223 of the storage node-side physical resource management table 422.

(5205) Allocated area: The table stores the information showing which area of the physical resource having the allocated flag 5204 set to yes has already been allocated. This information is the same as the allocated area 4224 of the storage node-side physical resource management table 422.

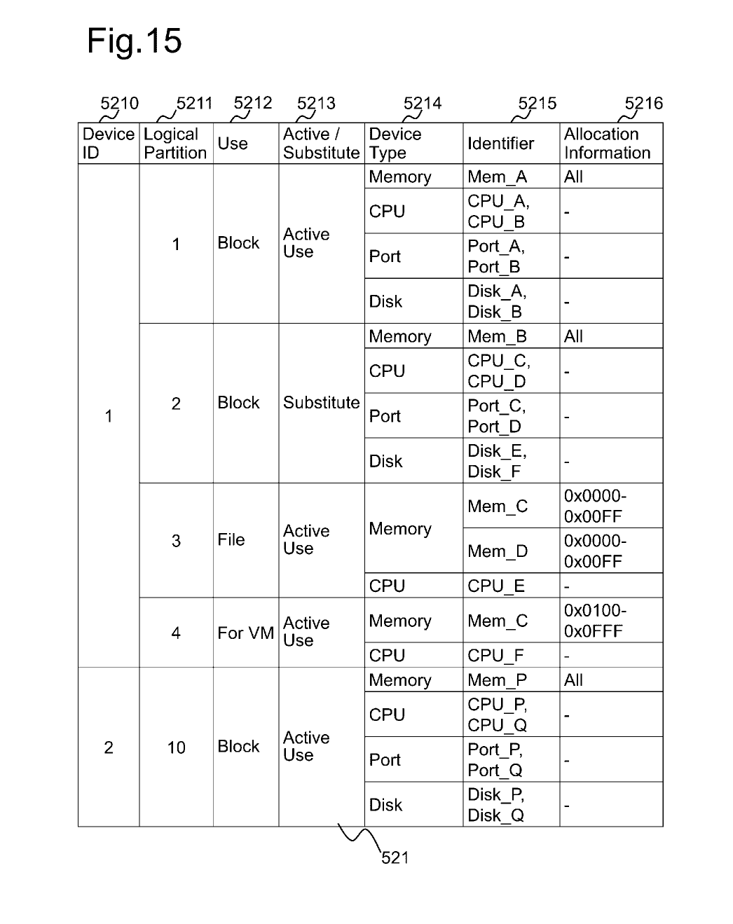

FIG. 15 illustrates a management-side logical partition configuration management table 521 stored in the memory 502 of the management server 50. The management-side logical partition configuration management table 521 aggregates the information in the storage node-side logical partition configuration management table 423 from multiple storage nodes 40, and arranges the information in a single table. Other than the identifier information of the devices, the table is the same as the storage node-side logical partition configuration management table 423. The management-side logical partition configuration management table 521 has the following information (5210) through (5216).

(5210) Device ID: The table stores the identifier of the device of the storage node 40.

(5211) Logical partition number: The table stores the number for identifying the logical partitions within the storage node 40. This information is the same as the logical partition number 4230 of the storage node-side physical logical partition configuration management table 423.

(5212) Purpose: The table stores the information showing the purpose of use of the logical partition. This information is the same as the purpose 4231 of the storage node-side physical logical partition configuration management table 423.

(5213) Active use/substitute flag: The table stores the information showing whether the logical partition is used in an actively used system or in a standby system. This information is the same as the active use/substitute flag 4232 of the storage node-side physical logical partition configuration management table 423.

(5214) Device type: The table stores the physical device type information such as the CPU, the memory, the port and the disk. This information is the same as the device type 4233 of the storage node-side physical logical partition configuration management table 423.

(5215) Identifier: The table stores the identifier of the physical resource shown in device type 5214. This information is the same as the identifier 4234 of the storage node-side physical logical partition configuration management table 423.

(5216) Allocation information: The table stores the information showing which area of the physical resource shown in device type 5214 is allocated to the logical partition 5211. This information is the same as the allocation information 4235 of the storage node-side physical logical partition configuration management table 423.

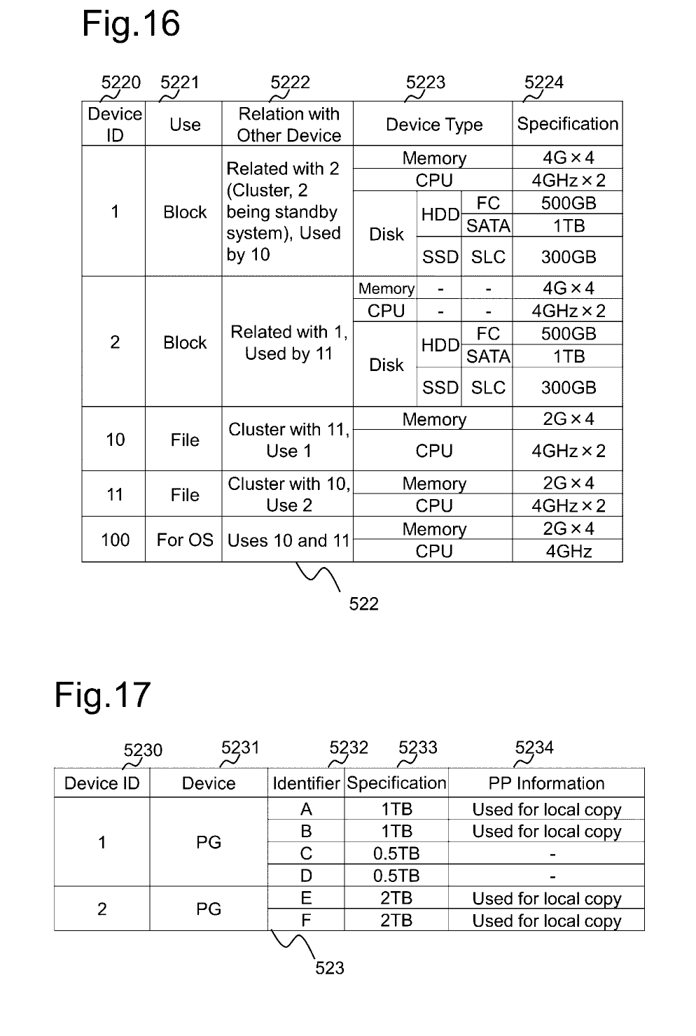

FIG. 16 illustrates a migration source configuration management table 522 stored in the memory 502 of the management server 50. The migration source configuration management table 522 collects the configuration management information (the file configuration management table 204 or the block configuration management table 304) of multiple management targets (such as block storages and file storages), and arranges the information in a single table. Other than the identifier of the device and the purpose, the present table is the same as the file configuration management table 204 or the block configuration management table 304. The migration source configuration management table 522 has the following information (5220) through (5224).

(5220) Device ID: The table stores the identifier of each device being the management target (such as the block storages or the file storages).

(5221) Purpose: The table stores the information showing the purpose of use of the migration source computer. Information such as block, file and OS are set.

(5222) Relation with other devices: The table stores the information on the relationship between the present device and other devices. This information is the same as the relation with other devices 2040 of the file configuration management table 204 or the relation with other devices 3040 of the block configuration management table 304. (5223) Device type: The table stores the type of physical resources used by the computer. This information is the same as the device type 2041 of the file configuration management table 204 or the device type 3041 of the block configuration management table 304.

(5224) Specification: The table stores the specification of the physical resource used by the computer. This information is the same as the information included in the device type 2041 of the file configuration management table 204 or the device type 3041 of the block configuration management table 304.

FIG. 17 illustrates a migration source PP management table 523 stored in the memory 502 of the management server 50. The migration source PP management table 523 aggregates PP management information of multiple block storages (block PP management table 305), and arranges the information in a single table. Other than the identifier of devices, the present table is the same as the block PP management table 305. The migration source PP management table 523 stores the following information (5230) through (5234).

(5230) Device ID: The table stores the identifier of respective devices being the management target (such as block storages and file storages).

(5231) Device type: The table stores the information on the type of resources that must be ensured by the PP of the block storage. This information is the same as the device type 3050 of the block PP management table 305.

(5232) Device identifier: The table stores the information for uniquely identifying a device 5231 within the block storage. This information is the same as the device identifier 3051 of the block PP management table 305.

(5233) Specification: The table stores the information showing the specification of the device 3050. If the device is a parity group (PG), for example, the information of the capacity is entered. This information is the same as the specification 3052 of the block PP management table 305.

(5234) PP information: The table stores the PP information utilized in the migration source block storage. This information is the same as the PP information 3053 of the block PP management table 305.

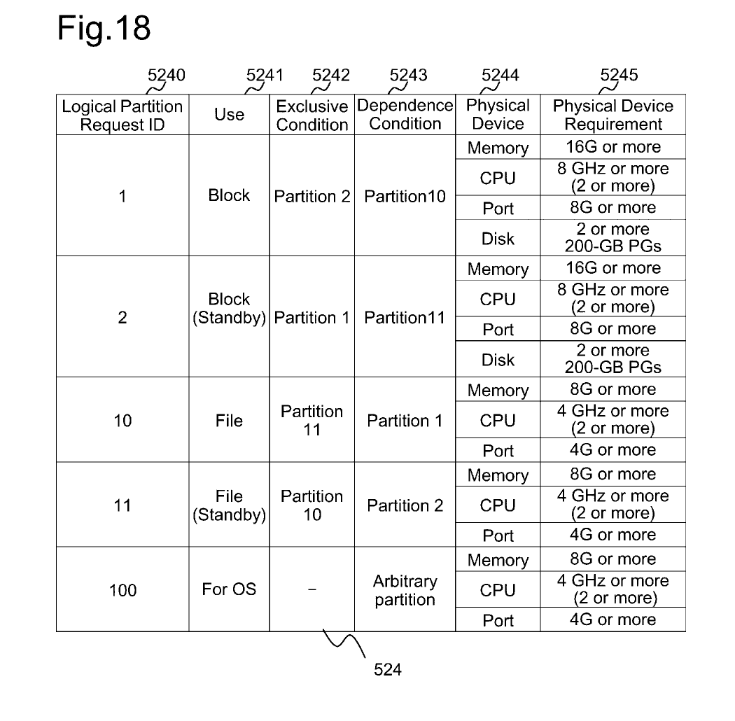

FIG. 18 illustrates the logical partition creation request management table 524 stored in the memory 502 of the management server 50. The logical partition creation request management table 524 stores conditions required in the logical partition planned to be created. The conditions include the information on whether the physical resource can be shared (dependence condition) or cannot be shared (exclusive condition) among different logical partitions. The logical partition creation request management table 524 includes the following information (5240) through (5245).

(5240) Logical partition request ID: The table stores IDs for identifying requests for creating logical partitions.

(5241) Purpose: The table stores the information showing the purpose of use of the logical partition. Information such as block storage, file storage and common OS can be stored, and additional information on whether the system is an actively used system or a standby system can also be stored.

(5242) Exclusive condition: The table stores the information on the logical partition that cannot share a physical resource when physical resources are virtualized and logically allocated to the logical partitions.

(5243) Dependence condition: The table stores the information on the logical partition capable of sharing a physical resource when physical resources are virtualized and logically allocated to the logical partitions.

(5244) Physical device: The table stores the type of the device required in the logical partition.

(5245) Physical device conditions: The table stores the conditions (specifications and numbers) of devices required in the logical partition.

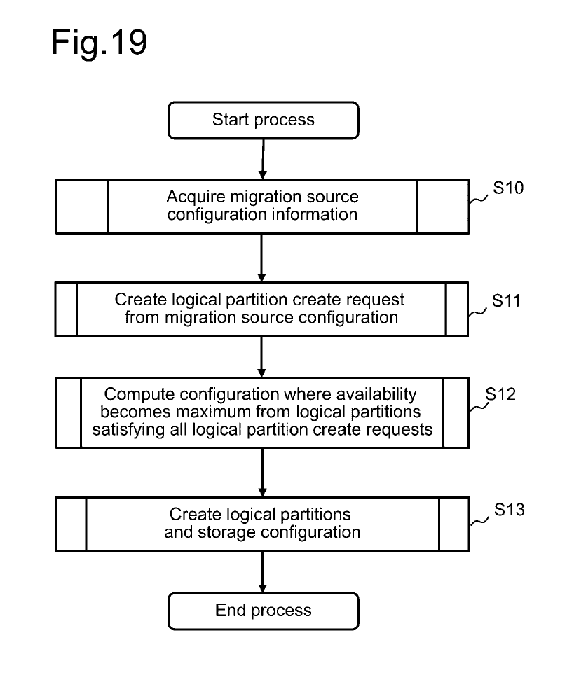

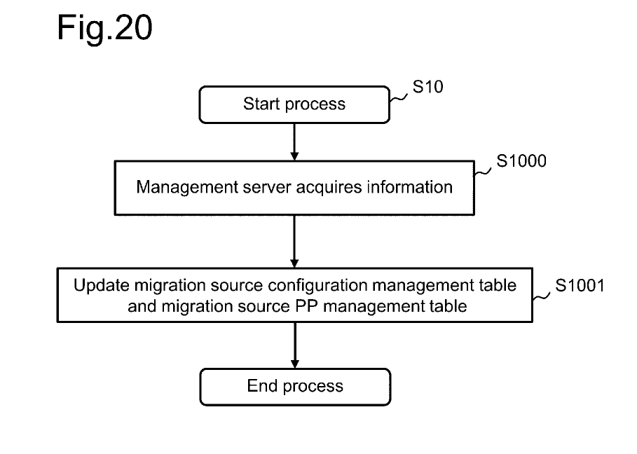

FIG. 19 is a view showing the overall outline of the flow of embodiment 1. In embodiment 1, logical partitions and storage configuration in which the availability becomes maximum are created when the configuration of the migration source computer system is realized in the migration destination storage node. The respective steps of the process will be described in the following. The details of each step will be described with reference to FIG. 20 and subsequent drawings.

(Step 10) The management server 50 acquires the configuration information of one or more computers of the migration source.

(Step 11) A logical partition creation request is created from the migration source configuration information. Here, the conditions that must be ensured in each logical partition to be created (exclusive condition) and the condition for sharing physical resources (dependence condition) are determined.

(Step 12) The method for creating logical partitions capable of satisfying the logical partition creation request of step 11 will be examined using limited resources of one or more storage nodes 40. The logical partition is created via a creation method in which the availability becomes maximum out of multiple creation methods. Now, according to the present invention, the ratio in which the exclusive condition was ensured in the respective logical partitions during creation of logical partitions for realizing the migration source configuration is set as the value of availability. Further in step 12, the method for creating logical partitions in which the value of availability becomes maximum is specified.

(Step 13) The logical partitions are created according to the method for creating logical partitions specified in step 12. Further, the storage configuration is also set.

FIG. 20 is a flowchart showing the details of the method for acquiring the migration source configuration information shown in step 10 of FIG. 19. Based on the present flowchart, the management server 50 can recognize the information of the respective physical resources being the management target of the migration source and the dependencies of the respective management targets. The respective steps will be described below.

(Step 1000) The management program 525 of the management server 50 communicates with the migration source computers (one or more host computers 10, one or more file storages 20 and one or more block storages 30) within the management target included in the computer system 1, and acquires the configuration information (the file configuration management table 204, the block configuration management table 304 and the block PP management table 305) from each of the computers. The user can select a portion of the migration source computers being the management target via the input screen or the like of the management program 525 of the management server 50.

(Step 1001) The management program 525 of the management server 50 uses the information acquired in step 1000 to update the migration source configuration management table 522 and the migration source PP management table 523. The information on the relation with other devices of the migration source configuration is not restricted to the information stored in each device, but can be created automatically from the physical connection configuration (such as the information that a storage area of a block storage is allocated to and used by a file storage, or that a file system of a file storage is mounted from an OS). Further, as shown in the modification example described later, the user can enter the information on the relation with other devices using a GUI (Graphic User Interface).

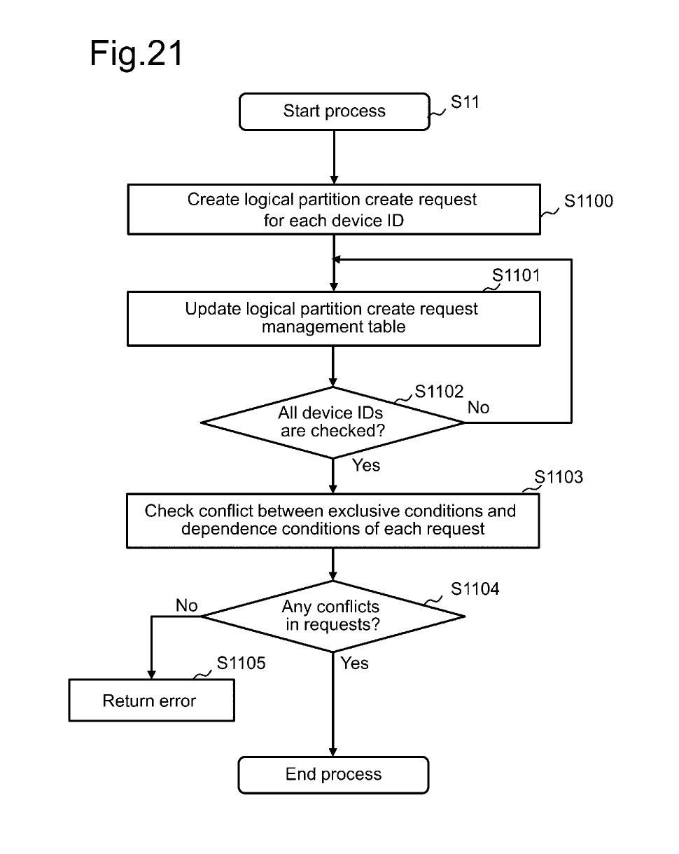

FIG. 21 is a flowchart showing the method for creating a logical partition creation request from a migration source configuration shown in step 11 of FIG. 19. Based on this flowchart, a logical partition creation request for realizing a logical configuration for migrating the configuration of a migration source system that must be created in the migration destination storage node 40 is created based on the physical resource information and PP information prior to migration and the relation information of each computer system. The steps of the present process will be described below.

(Step 1100) The management program 525 of the management server 50 creates a logical partition creation request for each migration source device using the information in the migration source configuration management table 522 and the migration source PP management table 523. The logical partition creation request includes conditions of the purpose, the exclusive condition, the dependence condition and the physical resource.

As an example, in the case of the device ID 1 in the migration source configuration management table 522 of FIG. 16, the logical partition creation request is as shown below. Since the purpose of the information of device ID 1 is block, the “purpose” of the request will be “block”. Especially when the logical partition is used in a standby system, condition information indicating “standby system” can be added to the “purpose” as supplementary information. As for the relation with other devices, device ID 1 is in a cluster relationship with device ID 2, and is used by device ID 10. Therefore, the logical partitions of device ID 1 and device ID 2 must always be operated independently, and the physical failure of the resource allocated to one of the logical partitions must not influence the other logical partition. Further, it is meaningless to activate device ID 10 independently unless device ID 1 is activated. Therefore, the “exclusive condition” is set as “logical partition of device ID 2”, and the “dependence condition” is set as the “logical partition of logical partition ID 10”.

Further, the conditions of the physical resources are set so that there are four 4-G memories and two 4-GHz CPU cores, and that the disks include a 500-GB FC disk, a 1-TB SATA and a 300-GB SSD. Further based on the information in the migration source PP management table 523, the device includes four parity groups, wherein the two parity groups out of the four constitute a local copy configuration. The local copy configuration is created for backup purpose, and the physical resources are intentionally partitioned, so that by taking availability into consideration, the conditions of the request of the physical resources includes the following conditions; “four 4-G memories”, “two 4-GHz CPUs”, and “1.8 TB disks with at least two parity groups”. If the set condition does not require the device to be physically separated from other computers, the exclusive condition column will be blank, and if the device is connected to all other computers, the dependence condition is set to “arbitrary”.

(Step 1101) The management program 525 of the management server 50 assigns a logical partition creation request ID, and sets the information of the logical partition creation request created in step 1100 to the logical partition creation request management table 524.

(Step 1102) The management program 525 of the management server 50 advances to step 1103 if the creation of the logical partition creation request is completed for all the device IDs stored in the migration source configuration management table 522. If it is not completed, the program returns to step 1101.

(Step 1103) The management program 525 of the management server 50 examines whether there is no conflict between the exclusive condition and the dependence condition in the information set in the logical partition creation request management table 524. At this point of time, at first, the logical partition ID of the exclusive condition and the dependence condition are not set. Therefore, the logical partition creation request ID is set as the logical partition ID to update the exclusive condition and the dependence condition of each record. In the example of FIG. 18, the logical partition request ID 1 is exclusive with respect to “the logical partition of device ID 2” and is dependent with respect to “the logical partition of device ID 10”. Since the requests corresponding to the IDs are 2 and 10, respectively, the exclusive condition and the dependence condition are updated to store partition 2 and partition 10, respectively. Since the exclusive condition and the dependence condition are mutually independent and the same conditions will not be stored therein, all the requests are checked for any conflicts caused by the same conditions being entered thereto.

(Step 1104) If there is any conflict between the exclusive condition and the dependence condition in the request, the procedure advances to step 1105. If there is no conflict, the present flow is ended.

(Step 1105) Since there is a conflict between the exclusive condition and the dependence condition, the management program 525 of the management server 50 notifies an error on the display or the like that the user uses via the input and output device 505.

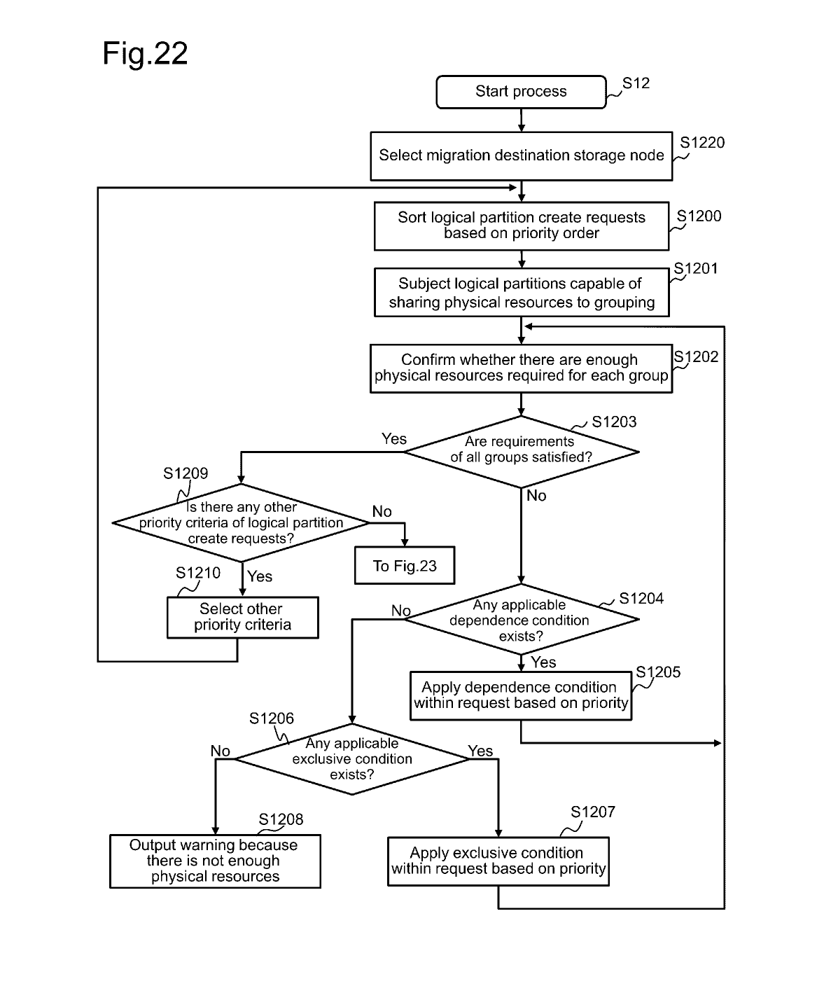

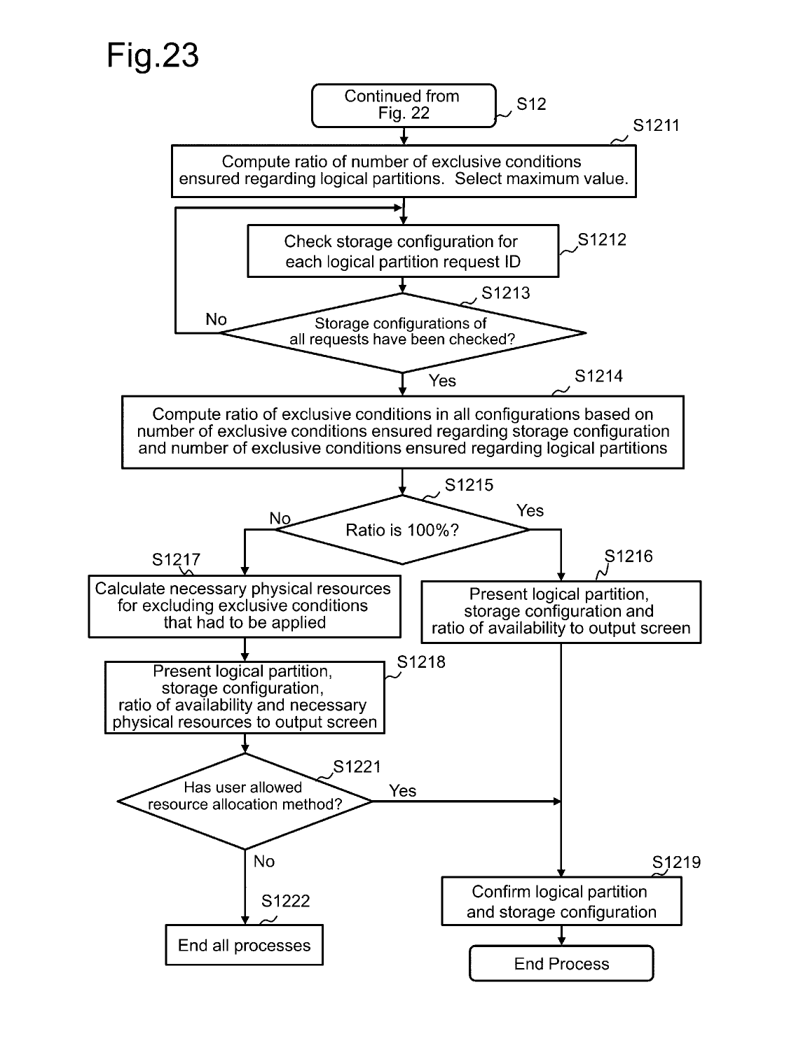

FIGS. 22 and 23 illustrate a flowchart describing the details of the method for creating a logical partition that satisfies the logical partition creation request of step 13 illustrated in FIG. 19. In the present flowchart, mainly the following three processes are performed.

(1) Derive a logical partition creation method that satisfies the logical partition creation request;

(2) Derive a storage configuration that satisfies the exclusive condition of the storage configuration of the logical partition creation request; and

(3) Specify the logical partition creation method in which the availability becomes maximum.

Ideally, it is preferable from the viewpoint of availability to allocate different independent physical resources respectively to each of the logical partitions. However, it may not be possible to create logical partitions which are all physically independent within the limited resource range of the migration destination storage node 40. Therefore, it is considered that the availability will not be deteriorated even if mutual logical partitions satisfying dependence conditions share a physical resource.

According to embodiment 1, methods for examining the logical partition creation methods that can be realized are examined sequentially. However, since the amount of calculation is excessive in order to calculate all realizable combinations, in embodiment b 1, the creation method is derived according to the priority described in detail later. Further, according to (3), the creation method that satisfies the most number of exclusive conditions in all the logical partition creation requests is determined to have the maximum availability. The respective steps will be described in detail below.

(Step 1220) The user selects one or more migration destination storage nodes 40 on the screen of the input and output device 505 or via CLI (Command Line Interface) of the management server 50. In the subsequent steps (step 1200 and thereafter), all the storage nodes 40 selected in step 1220 is considered as the migration destination.

(Step 1200) The management program 525 of the management server 50 sorts the requests of the logical partition creation request management table 524 based on the order of priority. Here, there may be multiple priorities. As an example, in the storage node 40, the logical partition for virtual block storages will be the partition being the basic point of all the simultaneously operating logical partition for virtual block storages, logical partition for virtual file storages and logical partition for common OS. Thereafter, the logical partition for virtual file storages is used based on the logical partition for virtual block storages. Then, a logical partition for common OS is used based on the logical partition for virtual file storages. Based on the above description, it is possible to set the priority in the named order of block, file, and common OS. Further, it is also possible to prioritize the actively used system over the standby system, and to set the priority in the named order: block (actively used system), file (actively used system), common OS, block (standby system), and file (standby system). In the present embodiment, the order of priority is set in the order of block, file and OS. Accordingly, in the example of the logical partition creation request management table 524 of FIG. 18, the device ID is sorted in the order of 1, 2, 10, 11 and 100.

(Step 1201) The management program 525 of the management server 50 executes grouping of logical partitions capable of sharing physical resources. The ideal configuration for ensuring the availability of the migration source is that the resources allocated to each of the logical partitions are all physically separated. Therefore, in the first groping, all independent physical resources are allocated to each of the logical partition creation requests. In the example of the logical partition creation request management table 524 illustrated in FIG. 18, the requests of the device IDs 1, 2, 10, 11 and 100 are respectively divided into groups 1, 2, 3, 4 and 5. Smaller number of groups means greater number of logical partitions capable of sharing physical resources.

(Step 1202) The management program 525 of the management server 50 examines using the management-side physical resource management table 520 of FIG. 14 whether a physical resource satisfying the logical partition creation requests included in each group exists in the storage node 40 or not. As an example, in case a greedy algorithm is adopted, at first based on priority, a vacant physical resource required in the block of the logical partition creation request ID 1 of group 1 is checked, and if such vacant physical resource exists, temporal allocation is performed, and thereafter, whether a vacant physical resource exists or not is examined for group 2 (logical partition creation request ID 2), group 3 (logical partition creation request ID 10), group 4 (logical partition creation request ID 11) and group 5 (logical partition creation request ID 100) in the named order. It is also possible to flexibly determine in advance that some conditions (such as the number of CPUs, the types of disks) do not have to be satisfied, and determine that the conditions for creating the logical partition is satisfied even if not all the conditions of physical resources being requested are satisfied.

(Step 1203) If the conditions of the logical partition creation request of all groups are satisfied, the procedure advances to step 1209. If not, the procedure advances to step 1204.

(Step 1204) The management program 525 of the management server 50 examines whether there exists a condition that is not used in the grouping of the logical partitions capable of sharing physical resources out of the dependence conditions of the respective requests in the logical partition creation request management table 524. If such condition exists, the procedure advances to step 1205. If not, the procedure advances to step 1206.

(Step 1205) The management program 525 of the management server 50 selects an unapplied dependence condition from the request having the lowest priority determined in step 1201, and performs grouping of the logical partitions capable of sharing physical resources again. As an example, based on the dependence condition of the logical partition request ID 100 having the lowest priority in FIG. 18, the program determines that the logical partition request ID 11 and the logical partition request ID 100 can share physical resources, and sets the following four groups.

Group 1 (Logical partition creation request ID 1)

Group 2 (Logical partition creation request ID 2)

Group 3 (Logical partition creation request ID 10)

Group 4 (Logical partition creation request ID 11 and logical partition creation request ID 100)

By applying the dependence condition, the conditions that must be ensured by the physical resources among the logical partitions are relieved, so that the possibility of allocation of the limited amount of physical resources to the respective logical partitions is enhanced. After performing re-grouping, the procedure returns to step 1202, where whether a physical resource that can be applied to each group is included in the storage node 40 or not is determined

(Step 1206) If the management program 525 of the management server 50 determines that there are not enough physical resources even if all dependence conditions are applied in the loop of steps 1202 through 1205, the exclusive conditions among the respective logical partitions are applied as dependence conditions to examine whether there are physical resources that can be allocated. The management program 525 of the management server 50 examines whether there are conditions not used in the grouping of logical partitions capable of sharing physical resources out of the exclusive conditions of the respective requests in the logical partition creation request management table 524. If there are such conditions, the procedure advances to step 1207, and if not, the procedure advances to step 1208.

(Step 1207) The management program 525 of the management server 50 re-executes grouping of the logical partitions capable of sharing physical resources by selecting an unapplied exclusive condition from the request having the lowest priority determined in step 1201. In the case of FIG. 18, if the exclusive conditions of the logical partition 10 and the logical partition 11 are applied as dependence condition to perform grouping, the following grouping is performed.

Group 1 (Logical partition creation request ID 1)

Group 2 (Logical partition creation request ID 2, Logical partition creation request ID 10, Logical partition creation request ID 11, Logical partition creation request ID 100)

After re-grouping is performed, the procedure returns to step 1202, where whether a physical resource capable of being applied to each group exists in the storage node 40 or not is checked.

(Step 1208) If a physical resource that can be allocated to the respective logical partitions cannot be found even by applying all exclusive conditions, it means that there is not enough physical resources in the migration destination storage node 40 from the beginning, so that the management program 525 of the management server 50 notifies an error message indicating that there is not enough physical resource on a display or the like of the input and output device 505 of the management program 525.

(Step 1209) In addition, whether priority is set to the logical partition or not is checked, and if priority is set, the procedure advances to step 1210. If not, the procedure advances to step 1211.

(Step 1210) The management program 525 of the management server 50 selects an unapplied priority (for example, the order of actively used system and standby system), and returns to step 1200.

(Step 1211) The number of exclusive conditions that could be ensured in the flow up to step 1209 is checked, and the ratio of the number to the whole number is calculated. The grouping having the maximum ratio is adopted.

(Step 1212) The exclusive condition of the storage configuration is checked for each logical partition creation request. In the example of the logical partition request ID 1 of FIG. 18, the exclusive condition of the storage configuration is that there are two or more 200-GB parity groups. In the exclusive conditions of the storage configuration, the number of exclusive conditions that can be ensured is checked.

(Step 1213) If all the exclusive conditions of the storage configuration have been checked for all logical partition creation requests, the procedure advances to step 1214. If not, the procedure returns to step 1212.

(Step 1214) The management program 525 of the management server 50 checks the ratio of the number of exclusive conditions that could be ensured regarding the storage configuration and the number of exclusive conditions that could be ensured regarding the logical partitions with respect to all the exclusive conditions of the storage configuration and the logical partitions.

(Step 1215) If the ratio of exclusive conditions that could be ensured with respect to all the exclusive conditions of the storage configuration and the logical partitions is 100%, the procedure advances to step 1216. If not, the procedure advances to step 1217.

(Step 1216) The management program 525 of the management server 50 displays the configuration of the created logical partitions, the storage configuration and the availability on a display or the like of the input and output device 505.

(Step 1217) The management program 525 of the management server 50 computes conditions of physical resources necessary for excluding the exclusive condition that had to be applied. For example, if two more 4-GB physical memories had to be provided to satisfy all the exclusive conditions of the logical partitions, and if two more HDDs had to be provided to satisfy the parity group conditions, the program determines that there is a “lack of 4-GB physical memory” and a lack of “two 200-GB HDDs”.

(Step 1218) The management program 525 of the management server 50 displays the configuration of the logical partitions being created, the storage configuration, the availability and necessary physical resources on the display or the like of the input and output device 505.

(Step 1219) The management program 525 of the management server 50 confirms the method for creating logical partitions, stores the information of the logical partitions being created to the management-side logical partition configuration table 521, and ends the process.

(Step 1221) The user enters via the display or the like of the input and output device 505 whether to create logical partitions or storage configuration based on the contents of the configuration shown on the screen or the like of the input and output device 505 of the management server 50. If the user provides permission to perform creation based on the displayed configuration, the procedure advances to step 1219. If not, the procedure advances to step 1222.

(Step 1222) The management program 525 of the management server 50 ends all the processes for creating logical partitions and creating storage configuration.

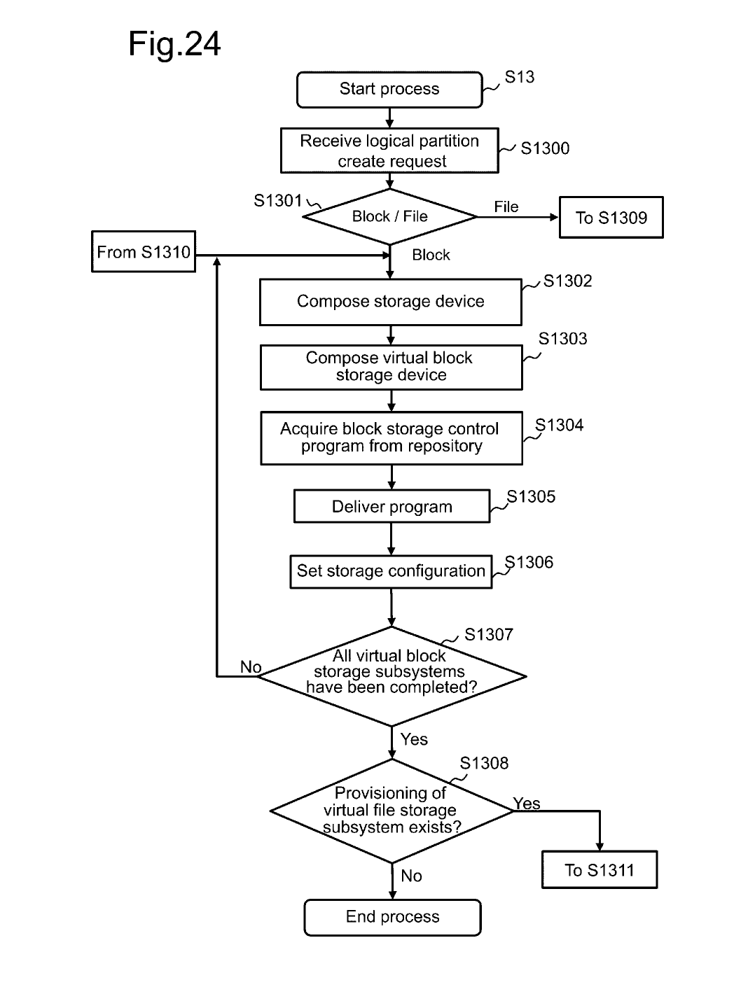

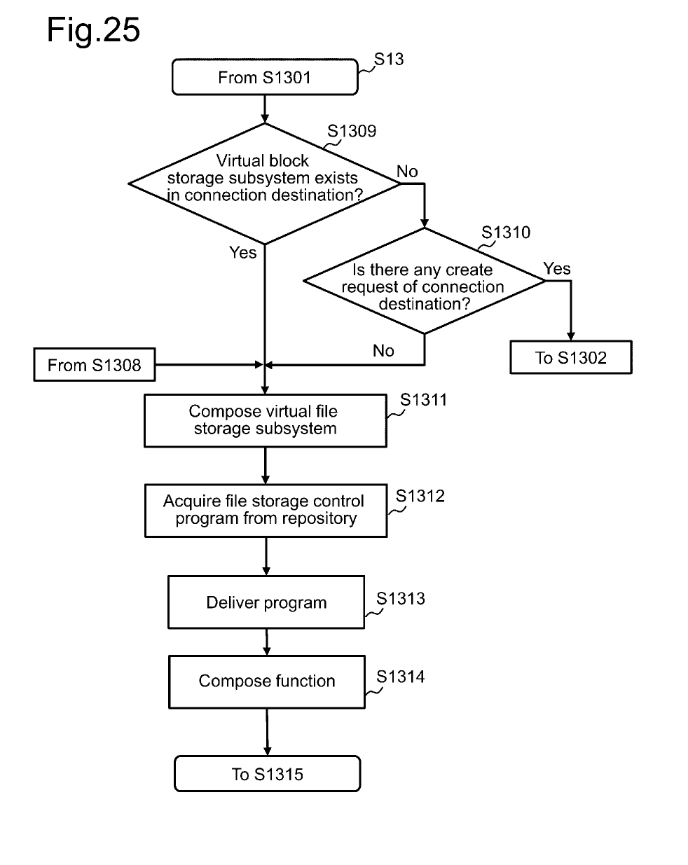

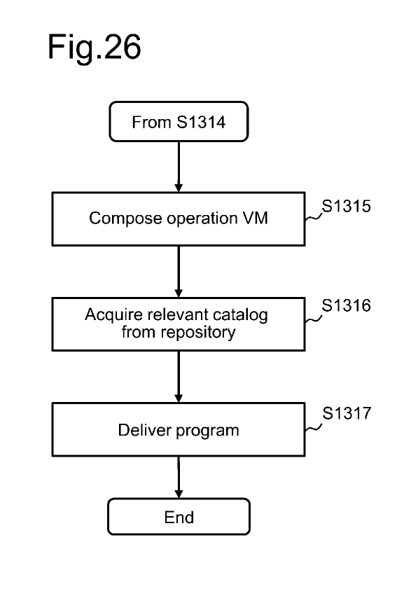

FIGS. 24, 25 and 26 illustrate the process for subjecting the logical partitions to provisioning after determining the physical resources for creating the logical partitions and the storage configuration. If the virtual storage subsystem performing provisioning includes a virtual file storage subsystem and a virtual block storage subsystem, the management program 525 performs provisioning of the virtual block storage subsystem prior to performing provisioning of the virtual file storage subsystem.

(Step 1300) The management program 525 of the management server 50 receives a request of a virtual storage out of the logical partition creation requests ensured in step 1219.

(Step 1301) If the logical partition creation request denotes a virtual block storage subsystem, the procedure advances to step 1302. If the request denotes a virtual file storage subsystem, the procedure advances to step 1310.

(Step 1302) The management program 525 of the management server 50 performs settings in a node so that the physical resources of the configuration determined in step 1219 can be recognized by the logical partitioning program 420.

(Step 1303) The management program 525 of the management server 50 performs settings of a logical partition for activating the virtual block storage subsystem with respect to the logical partitioning program 420 of the storage node 40. The logical partitioning program 420 creates a logical partition of the designated physical resource in order to activate the virtual block storage subsystem.

(Step 1304) The management program 525 of the management server 50 selects the block storage control program 542 of the same migration source block storage from the repository 504 of the management server 50.

(Step 1305) The management program 525 of the management server 50 delivers the block storage control program 542 selected in step 1304 to the storage node 46.

(Step 1306) The management program 525 of the management server 50 creates a storage configuration determined in step 1219.

(Step 1307) When the provisioning of all virtual block storage subsystems is completed, the procedure advances to step 1308. If not, the procedure advances to step 1302.

(Step 1308) If there is a virtual file storage subsystem that must be subjected to provisioning, the procedure advances to step 1311. If not, the process is ended.

(Step 1309) The management program 525 of the management server 50 checks whether there already exists a connection destination virtual block storage subsystem of the virtual file storage subsystem (whether provisioning of the virtual block storage subsystem is necessary) or not. If there already exists such subsystem, the procedure advances to step 1311. If not, the procedure advances to step 1310.

(Step 1310) The management program 525 of the management server 50 selects a create request of the connection destination virtual block storage subsystem of the virtual file storage subsystem, if any, and advances to step 1302. If not, the procedure advances to step 1311.

(Step 1311) The management program 525 of the management server 50 performs setting of the logical partition for activating the virtual file storage subsystem with respect to the logical partitioning program 420 of the storage node 40. The logical partitioning program 420 creates logical partitions of the designated physical resource so as to activate the virtual file storage subsystem.

(Step 1312) The management program 525 of the management server 50 selects the file storage control program 543 that is the same as the migration source file storage from the repository 504 of the management server 50.

(Step 1313) The management program 525 of the management server 50 delivers the file storage control program 543 selected in step 1312 to the storage node 40.

(Step 1314) The management program 525 of the management server 50 constitutes (sets up) the functions of the virtual file storage subsystem with respect to the file storage control program 543. Thereafter, the management program 525 constitutes a file system in the virtual file storage subsystem similar to the migration source file storage subsystem. These steps are similar to setting a normal file storage subsystem, so that detailed description of the steps will be omitted.

(Step 1315) The management program 525 of the management server 50 performs a logical partition setting for constituting an operation VM with respect to the logical partitioning program 420 and the virtualization program 468.

(Step 1316) The management program 525 of the management server 50 selects an operation catalog 541 including the same OS as the migration source host computer from the repository 504 of the management server 50.

(Step 1317) The management program 525 of the management server 50 delivers the operation catalog 541 selected in step 1317 to the storage node 40.

Embodiment 1 according to the present invention has been described, but the present embodiment is a mere example for better understanding of the present invention, and is not intended to limit the scope of the invention in any way. The present invention allows various modifications. For example, the respective configurations, functions, processing units, processing means and the like in the present invention can be realized via hardware, such as by designing a portion or all of the components on integrated circuits. The information such as programs, tables and files for realizing the respective functions can be stored in storage devices such as nonvolatile semiconductor memories, hard disk drives and SSDs (Solid State Drives), or in computer-readable non-temporary data storage media such as IC cards, SD cards and DVDs. Furthermore, regarding the process of determining the logical partitions after migration and the creation of logical partitions, it is possible to create multiple logical partitions having different availabilities and different physical resources in advance, select a logical partition satisfying the requirements of the logical partition creation request based on priority, perform provisioning of the virtual storage subsystem and the virtual server to determine the logical partition after migration, and create virtual storage subsystems and virtual servers.

Based on the embodiments of the present invention, it becomes possible to propose and determine a method for creating logical partitions and a method for setting storage configurations for maximizing availability using limited resources based on the requirements of availability of the computer system prior to migration in the computer system of embodiment 1, so as to realize creation of a virtual storage subsystem and a virtual server having high availability.

<Modified Example of Embodiment 1>

As a modified example of embodiment 1, one example of a method for enabling setting of information in the migration source configuration management table and the migration source PP management table illustrated in step 1001 of FIG. 20 via a GUI is illustrated.

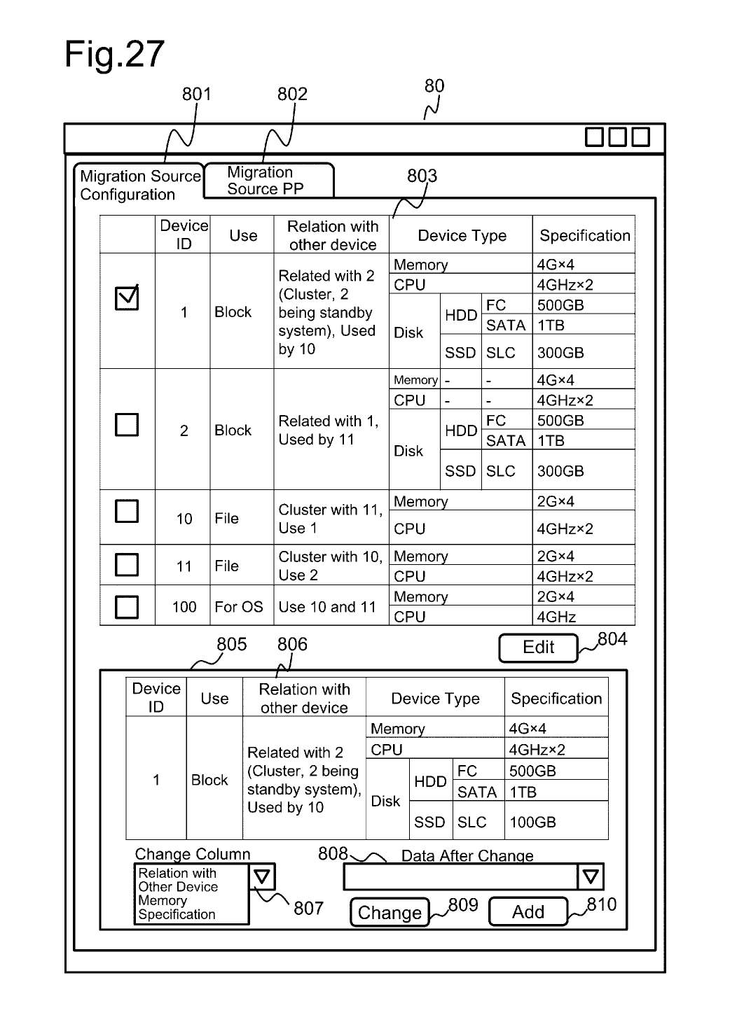

FIG. 27 is an example of a GUI 80 displayed on the input and output device 505 for correcting the information in the migration source configuration management table and the migration source PP management table that the management server 50 has gathered from management targets in step 1000 of FIG. 20.

A GUI 80 is composed of a screen 801 for correcting the information in the migration source configuration management table 522, and a screen 802 for correcting the information in the migration source PP management table 523. In FIG. 27, the screen 801 and the screen 802 are illustrated to be switched via tabs, but the method is not restricted to such example, and the screens can be switched via arbitrary screen switching mechanisms such as a tool bar, or the screens 801 and 802 can be displayed simultaneously on the same screen.

FIG. 27 shows an example where the tab of screen 801 is selected. The screen 801 includes a table 803 including the data of the migration source configuration management table and a checkbox for selecting the device ID being the target of editing, an edit button 804 for determining the device ID for editing data, a screen 805 showing the information for changing the configuration information of the device after determining the device ID for editing data, a table 806 showing the information of the migration source configuration management table of the selected device ID, a pull-down 807 for selecting the column being the target to be changed, a pull-down 808 for entering the data after change, a button 809 for confirming the change via the entered information, and a button 810 for adding the entered information. The method for specifying the device ID in table 803 is not restricted to checkboxes, and other method of display capable of specifying the device ID can be adopted. Moreover, the input of changed columns or data after change does not have to be performed via a pull-down menu, and any GUI capable of specifying and entering information can be adopted. Moreover, the screen 805 is not necessarily included in the screen 801, and for example, the screen can be displayed as a separate window after clicking the edit button 804. The screen 802 for correcting the information in the migration source PP management table 523 also has the GUI equivalent to the button 810 described above in the table 803.

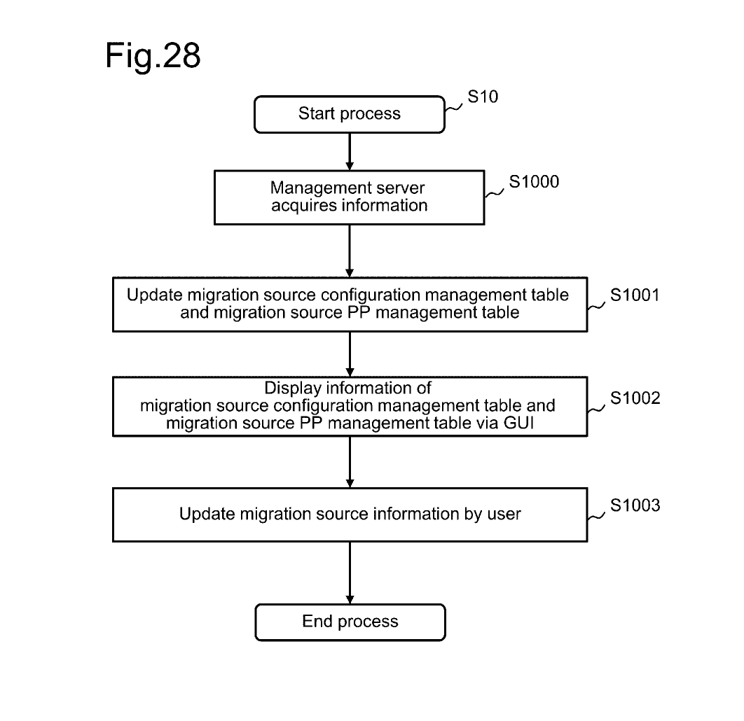

FIG. 28 is a flowchart for acquiring the configuration information prior to migration, which is a modified example of the flowchart of FIG. 20. Steps up to step 1001 are the same, and step 1002 and thereafter are additionally provided.

(Step 1002) The management program 525 of the management server 50 displays the information of the migration source configuration management table 522 and the migration source PP management table 523 via the GUI 80 in the input and output device 505.

(Step 1003) The user updates the information of the migration source using the GUI 80. An example is described with reference to FIG. 27. A state is considered in which the user wishes to add information of the relation with other devices of device ID 1 stating that the device is utilized by the device ID 100. At first, the user selects the device ID that he/she wishes to change in the table 803 on the screen 801. Next, the user clicks the edit button 804 to display the screen 805 showing the information of the migration source configuration management table of the selected device ID. The user clicks the pull-down 807 of the change column, and selects the “relation with other devices”, according to which the pull-down 808 of changed data enables the user to select information that can be added to the “relation with other devices”. The user selects the area in the pull-down 808 stating that “device ID 100 uses the device”, and clicks the add button 810, by which the management program 525 of the management server 50 updates the information in the migration source configuration management table 522. As described, the user can additionally set the information corresponding to the exclusive condition and the dependence condition.

The modified example of embodiment 1 according to the present invention has been described, but this example has been illustrated merely for better understanding of the present invention, and is not intended to restrict the scope of the present invention in any way. The present invention can be realized in various other forms. For example, the example of a GUI has been illustrated in FIG. 27, but a CLI can also be used to display and edit the information prior to migration. Further, the data is not only changed or added, but can be deleted as well. Furthermore, the data section after change can be entered manually by the user. In that case, the information entered by the user does not necessarily have to match the conditions required in the configuration of the migration source, or it is possible to check whether there are any logical conflicts between the existing information and the current configuration.

As an example of the former case, if the block storage and the file storage are formed in different casings in the migration source configuration, but it is better to have the logical partitions of the virtual block storage subsystem and the logical partitions of the virtual file storage subsystems to exist within the same storage node in the migration destination storage node (considering performance or the like), the user can add a condition as one of the conditions that must be ensured in the migration destination logical partition that the logical partitions for the block and the logical partitions for the file are composed within the same storage node. As an example of the latter case, it is possible to perform a check when entering a condition assuming that the multiple computers not being connected physically in the migration source configuration is connected in the migration destination.

According to the computer system of the modified example of embodiment 1 of the present invention, it becomes possible to propose and determine the method for creating logical partitions and the method for setting storage configurations capable of maximizing the availability using restricted resources based on the requirements of availability of the computer system prior to migration and the availability conditions entered by the user, to thereby realize creation of a virtual storage subsystem and a virtual server having high availability.

### Embodiment 2

Now, with reference to the drawings, a second preferred embodiment of the present invention will be described. Only the differences with respect to embodiment 1 are described in the second embodiment.

In embodiment 2, one example of the process for deleting one or more logical partitions of the storage node 40 having logical partitions already created, recomputing the overall availability and newly creating logical partitions will be illustrated. The differences of the present embodiment from embodiment 1 are the following three points.

(1) The logical partitions are deleted first and physical resources are released thereafter.

(2) Next, the logical partition creation request is created using the conditions designated by the user.

(3) The allocated information of physical resources are deleted.

The following process is the same process as steps S 12 and thereafter of the process flow illustrated in FIG. 19.

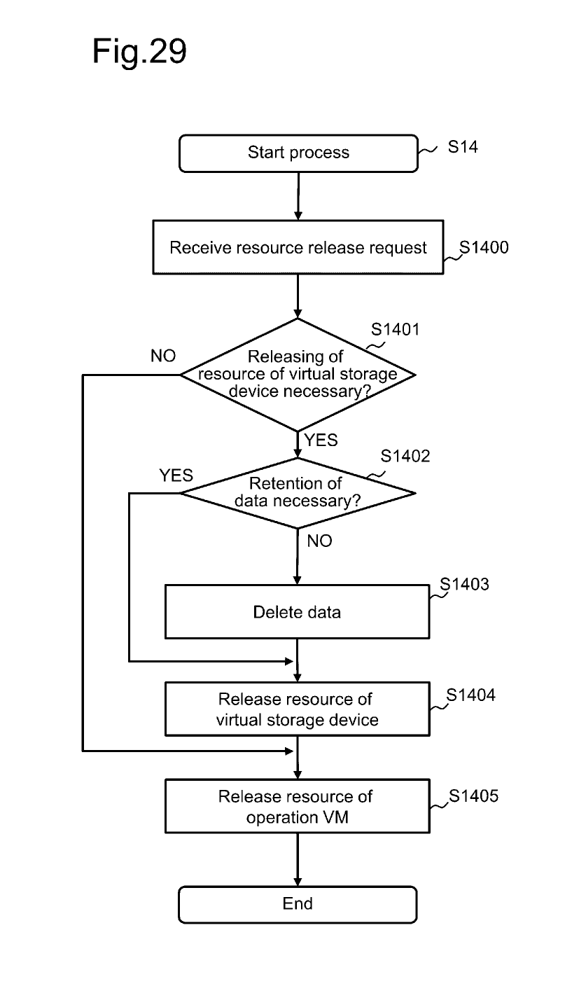

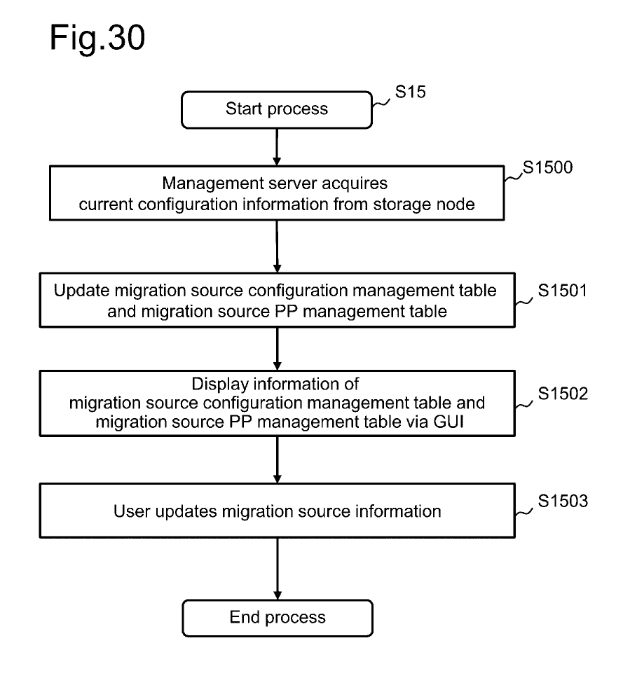

Hereafter, point (1) will be described with reference to FIG. 29. Further, point (2) will be described with reference to FIG. 30. As for point (3), the only differences are that a step of deleting an allocated area 5205 from the management-side physical resource management table 520 is added prior to processing step 1202 of FIG. 22, and that a step of deleting the information of the management-side logical partition configuration table 521 is added prior to processing step 1219 of FIG. 23, so that a flowchart thereof will not be shown.

FIG. 29 is a flowchart illustrating one example of the process showing the releasing of physical resources. FIG. 29 is a flowchart for deleting a single logical partition, and if it is necessary to delete two or more logical partitions, the flow of FIG. 29 should be performed repeatedly. The respective steps will be described below.

(Step 1400) The management program 525 of the management server 50 receives a resource release request from the user. The resource release request includes the VM to be deleted (including the virtual storage subsystem), and the designation on whether to delete or maintain the user data of the virtual storage subsystem (designation of data to be maintained). For example, in deleting a virtual file storage subsystem, the user can designate the file or the directory to be maintained. Further, in deleting a virtual block storage subsystem, the user can designate the data in a specific address area, for example.

(Step 1401) The management program 525 of the management server 50 refers to the received resource release request, and determines whether releasing of resource of the virtual storage subsystem (virtual block storage subsystem or virtual file storage subsystem) is necessary or not. If release is necessary, the procedure advances to step 1402. If release is not necessary, the procedure advances to step 1405.

(Step 1402) The management program 525 of the management server 50 determines whether to maintain the designated user data stored in the virtual storage subsystem or not. If specific data should be maintained, the procedure advances to step 1404. If specific data should not be maintained, the procedure advances to step 1403. The use case for maintaining data is, for example, a case where the conditions of performance of the first storage subsystem and the second storage subsystem differ, wherein a first virtual storage subsystem used as archive and not required to have high performance is arranged, and after data is accumulated, the first virtual storage subsystem is released while maintaining the relevant data, and a second virtual storage subsystem required to have high throughput used for data processing and taking over the relevant data is disposed thereafter. Thereby, data can be taken over from one phase to another of the system having limited resources while changing the specifications and numbers of the virtual storage subsystems and operation VMs.

(Step 1403) The management program 525 of the management server 50 deletes the data retained in the relevant virtual storage subsystem. Actually, the management program 525 orders to delete data to the relevant virtual storage subsystem. For example, the function of the storage device allocated to the logical partition activated in the relevant virtual storage can be used, or the data deleting function can be used by the logical partitioning program 420.

(Step 1404) The management program 525 of the management server 50 orders to stop the relevant virtual storage to the logical partitioning program 420, and to designate releasing of resource of the logical partition having been utilized by the relevant virtual storage subsystem after stopping the storage. Now, the management program 525 updates the information of the relevant logical partition of the storage node-side logical partition configuration management table with respect to the storage node 40, and further updates the information of the corresponding logical partition in the management-side logical partition configuration management table within the management server 50. Actually, the management program 525 deletes the entry corresponding to the logical partition of the relevant virtual storage subsystem.

(Step 1405) The management program 525 of the management server 50 orders to release the resource of the operation VM to the virtualization program 468 or the logical partitioning program 420 of the storage node 40, updates the information of the relevant logical partition in the storage node-side logical partition configuration management table, and further updates the information of the relevant logical partition of the management-side logical partition configuration management table within the management server 50. Actually, the management program 525 deletes the entry corresponding to the relevant logical partition.

FIG. 30 is an example of the flowchart of a case where the user re-constructs the logical partitions. The respective steps will be shown below. The flow is similar to the modified example of embodiment 1 illustrated in FIG. 28, but the point of acquiring the original configuration for creating a logical partition creation request from the current storage node differs.

(Step 1500) The management program 525 of the management server 50 communicates with the storage node 40 included in the computer system 1 and acquires the configuration information from the information stored in the storage node-side logical partition configuration management table 423.

(Step 1501) The management program 525 of the management server 50 uses the information acquired in step 1500 to update the migration source configuration management table 522 and the migration source PP management table 523. When logical partitions differ, they are assumed to be different devices. The information on the relation with other devices of the migration source configuration is not restricted to information stored in the respective devices, but can be created automatically based on the physical connection configuration (such as the storage area of the block storage being allocated and used by the file storage, or the file system of the file storage being mounted from the OS).

(Step 1502) The present step is the same as step 1002 of FIG. 28. That is, the management program 525 of the management server 50 displays the information of the migration source configuration management table 522 and the migration source PP management table 523 via the GUI 80 within the input and output device 505.

(Step 1503) The present step is the same as step 1003 of FIG. 28. In other words, the user uses the GUI 80 to update the migration source information. One example thereof will be described using FIG. 27. A state is considered where the user wishes to add information to the relation with other devices of device ID 1 stating that the device is used by device ID 100. At first, the user selects the device ID that he/she wishes to change in the table 803 on the screen 801. Next, when the user clicks the edit button 804, a screen 805 showing the information of the migration source configuration management table of the selected device ID is displayed. The user clicks the pull-down 807 of the change column, selects the “relation with other devices”, according to which the information capable of being added to the “relation with other devices” can be selected by the user via the pull-down 808. When the user selects the statement “used by device ID 100” displayed via the pull-down 808 and clicks the add button 810, the management program 525 of the management server 50 updates the information in the migration source configuration management table 522. Thereby, the user can additionally set the information corresponding to the exclusive condition and the dependence condition.

The second embodiment of the present invention has been illustrated, but this is a mere example for better understanding of the present invention, and it is not intended to restrict the scope of the present invention in any way. The present invention can be realized via other various forms.

According to the present embodiment, the computer system of embodiment 2 enables to propose and determine a method for creating logical partitions and a method for setting storage configuration capable of maximizing the availability by re-computing the availability using all physical resources of the storage node, to thereby realize creation of a virtual storage subsystem and virtual server having high availability.

### Embodiment 3

Now, a third embodiment of the present invention will be described with reference to the drawings. In the description of embodiment 3, only the differences with respect to embodiments 1 and 2 will be described.

Embodiment 3 illustrates an example of the process for re-computing the overall availability and creating a new logical partition when migrating a storage system or a host OS newly to a storage node 40 in which logical partitions are already created.

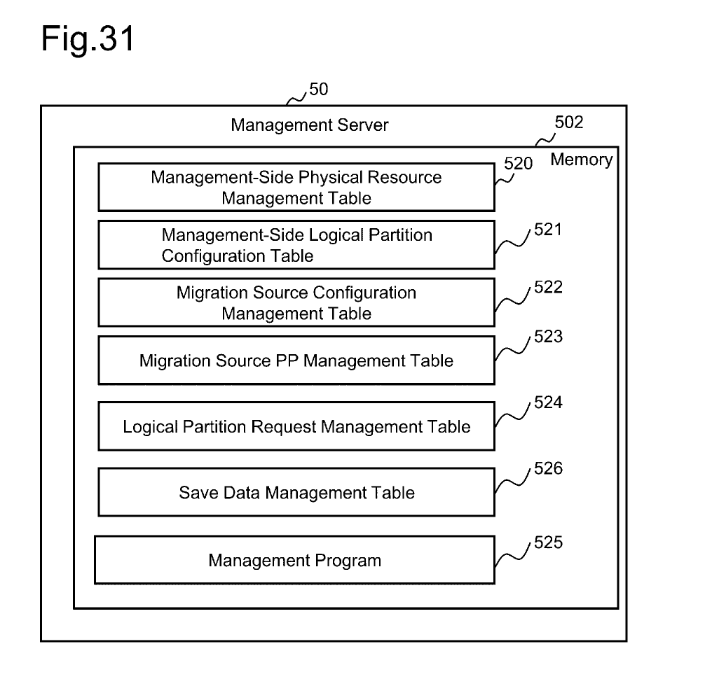

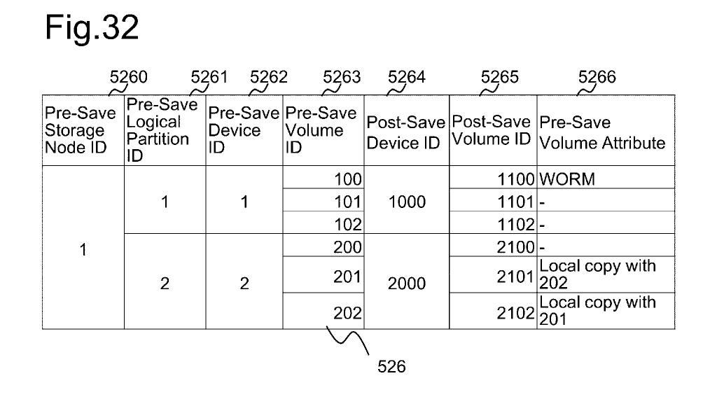

FIG. 31 is an example of the tables and programs stored in the memory 502 of the management server 50. The difference between the present embodiment and the management server 50 of FIG. 8 according to embodiment 1 is that a save data management table 526 is added to the memory.

The save data management table 526 is a table for managing the data when saving the data included in an existing virtual block storage system in order to additionally migrate a storage system or a host OS to the storage node 40. The save data management table 526 includes the following information (5260) through (5266).

(5260) Pre-save storage node ID: The table stores an identifier of the storage node 40 prior to saving.

(5261) Pre-save logical partition ID: The table stores an identifier of the logical partition of the virtual block storage subsystem prior to saving.

(5262) Pre-save device ID: The table stores an identifier of the virtual block storage subsystem prior to saving.

(5263) Pre-save volume ID: The table stores an identifier of the volume having been saving data prior to saving data.

(5264) Post-save device ID: The table stores an identifier of a block storage after saving data.

(5265) Post-save volume ID: The table stores an identifier of a volume saving data after saving data.

(5266) Pre-save volume attribute: The table stores an attribute information of the volume accompanying the volume prior to saving data. For example, the information accompanying the volume is, for example, a WORM (Write Once Read Many) function where writing of data can be performed only once, or a copy information with other volumes. For example, it is possible to display multiple attributes in a single column such as in 5266, or a number of columns corresponding to the number of attributes can be arranged.

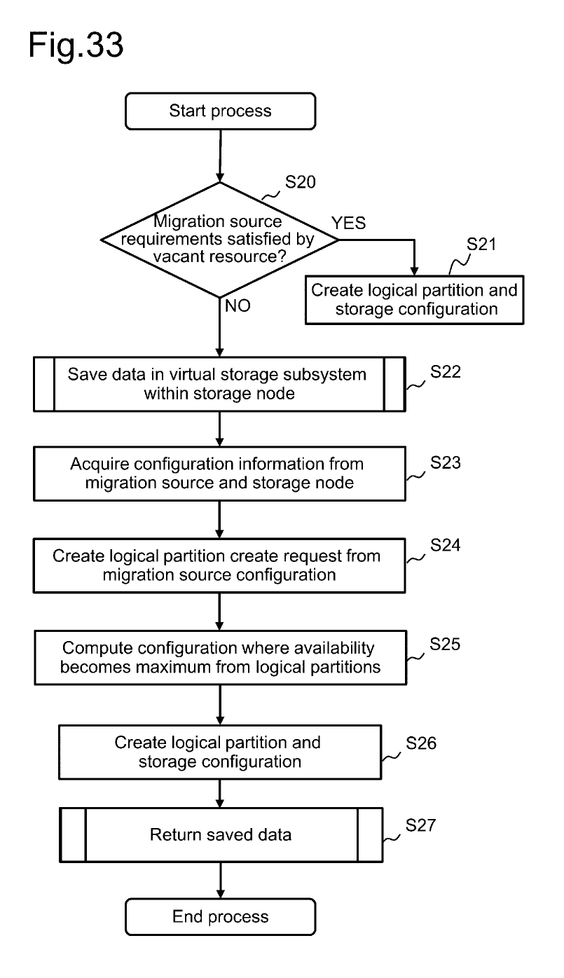

FIG. 33 is a view showing the overall outline of the flowchart according to embodiment 3. Now, the respective steps of the overall outline will be described. (Step 20) The procedure checks whether the migration source requirements to be added are satisfied only via the vacant resources of the current storage node. If the requirements are satisfied, the procedure advances to step 21. If the requirements are not satisfied, the procedure advances to step 22. Whether the requirements are satisfied or not is determined by performing all the processes of step 10 of FIG. 19, all the processes of step 11, and steps 1200 through 1215 of FIGS. 22 and 23 of the first embodiment, and when the result of step 1215 is Yes, the procedure determines that the requirements are satisfied.

(Step 21) Based on the result of step 20, the logical partitions and the storage configuration are created. In other words, all the processes from step 1216 of FIG. 23 to step 13 of FIG. 19 (to step 1317) are executed.

(Step 22) Since the vacant resources of the current storage node do not satisfy the migration source requirements, it is necessary to re-create the logical partitions. Therefore, the data in the existing virtual storage subsystem is saved in a different storage subsystem.

(Step 23) Configuration information is acquired from the migration source computer and the current storage node. This process is basically the same as the process of step 10 of FIG. 20 of embodiment 1 or step 10 of FIG. 28 of the modified example of embodiment 1. The difference is that the information acquisition target of the management server differs in step 1000. Actually, the management program 525 of the management server 50 communicates with the management target included in the computer system 1 (the host computer 10, the file storage 20, the block storage 30 and the storage node 40), and acquires the configuration information.

(Step 24) This step is substantially the same as step 11 of FIG. 19. That is, a logical partition creation request is created from the configuration information acquired in step 23. The difference from embodiment 1 is that according to the present embodiment, in order to uniquely set the logical partition identification information for returning the saved data, a logical partition identifier of the save data is set to the request ID of the logical partition creation request.

(Step 25) This step is substantially the same as step 12 of FIG. 19. That is, a method for creating a logical partition that satisfies the logical partition creation request of step 11 using the limited resources of one or more storage nodes 40 is examined The logical partition in which the availability becomes maximum out of the multiple creation methods is created. In the present invention, as a reference of availability, the ratio in which each logical partition has ensured the exclusive condition to be ensured during creation of logical partitions for realizing the migration source configuration is set as the availability value. Further in step 12, a method for creating the logical partition where the availability value becomes maximum is specified.

(Step 26) This step is substantially the same as step 13 of FIG. 19. That is, the logical partitions are created based on the method for creating logical partitions specified in step 25. Further, the storage configuration is also set. The difference of the present embodiment from embodiment 1 is that the host computers connected to the VMs in all the logical partitions are all set to off-line status.

(Step 27) The data having been saved in step 22 is returned to the original logical partition.

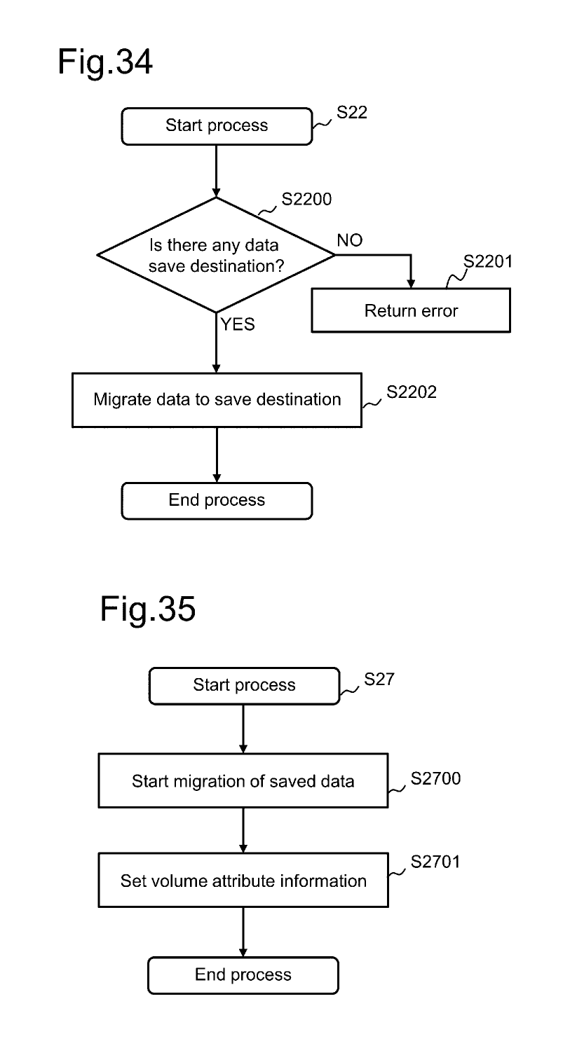

Now, the details of step 22 will be described with reference to FIG. 34, and the details of step 27 will be described with reference to FIG. 35.

At first in FIG. 34, the details of step 22 of the overall outline illustrated in FIG. 33 will be described. Hereafter, the respective steps will be described.

(Step 2200) The management program 525 of the management server 50 searches from all the block storage subsystems and storage nodes being the target of management whether there is a storage subsystem capable of saving the data retained in the storage node 40 being the target of re-calculation of logical partitions. If the save destination of data exists, the procedure advances to step 2202. If the save destination of data does not exist, the procedure advances to step 2201.

(Step 2201) The management program 525 of the management server 50 notifies an error to the input and output device 505 of the management server, for example.

(Step 2202) The management program 525 of the management server 50 saves the data to the save destination searched in step 2200. The method for saving data can be the copying of data via the host computer, copying of data among file storages, or copying of data using the copy function of the block storage subsystem. Moreover, the management program 525 acquires the volume attribute of the save source, and sets the pre-save information (storage node information, logical partition information, device identifier, volume identifier and volume attribute) and the post-save information (device identifier and volume information) to the save data management table 526.

Next, with reference to FIG. 35, the details of step 27 of the overall outline illustrated in FIG. 33 will be described. The following describes the respective steps.

(Step 2700) The management program 525 of the management server 50 starts data copy by checking the information in the save data management table 526. The method for copying data can be a method for copying data via a host computer, a method for copying data among file storages, or a method for copying data using the copy function of the block storage subsystem.

(Step 2701) The management program 525 of the management server 50 checks the information in the save data management table 526 and sets the volume attribute having been set with respect to the pre-save volume.

The third embodiment of the present invention has been described, but the embodiment is merely an example for better understanding of the present invention, and is not intended to limit the scope of the invention in any way. The present invention can be realized via other various forms.

The computer system according to embodiment 3 of the present invention proposes and determines a method for creating logical partitions and a method for setting storage configurations for maximizing the availability using restricted resource by recomputing the availability when one or more computer systems are migrated additionally, so as to realize creation of virtual storage subsystems and virtual servers having a high availability.

### Embodiment 4

Now, a fourth embodiment of the present invention will be described with reference to the drawings. In embodiment 4, only the differences with respect to embodiments 1, 2 and 3 will be illustrated.

Embodiment 4 illustrates an example of the process for creating logical partitions when a storage node 40 is newly introduced without having a migration source computer (host computer, file storage, block storage). Since there is no migration source computer, the conditions of availability of the logical partition created to the storage node 40 will be determined by the input from the user.

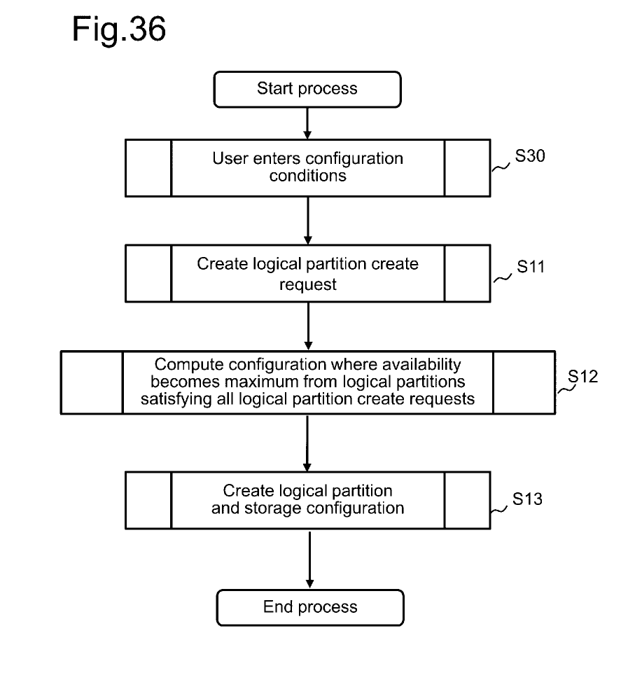

FIG. 36 is a view showing the overall outline of the flowchart of FIG. 4. Now, the respective steps of the overall outline will be described.

(Step 30) The user enters the configuration conditions of the virtual computer being activated by the logical partitions created to the storage node using the input device of the management server.

The following steps are the same processes as step 11 and subsequent steps of the overall flow shown in FIG. 19 illustrating embodiment 1.

Now, step 30, which is the difference from embodiment 1, will be described in detail, and one example of the method for entering configuration conditions by the user required in step 30 will be described.

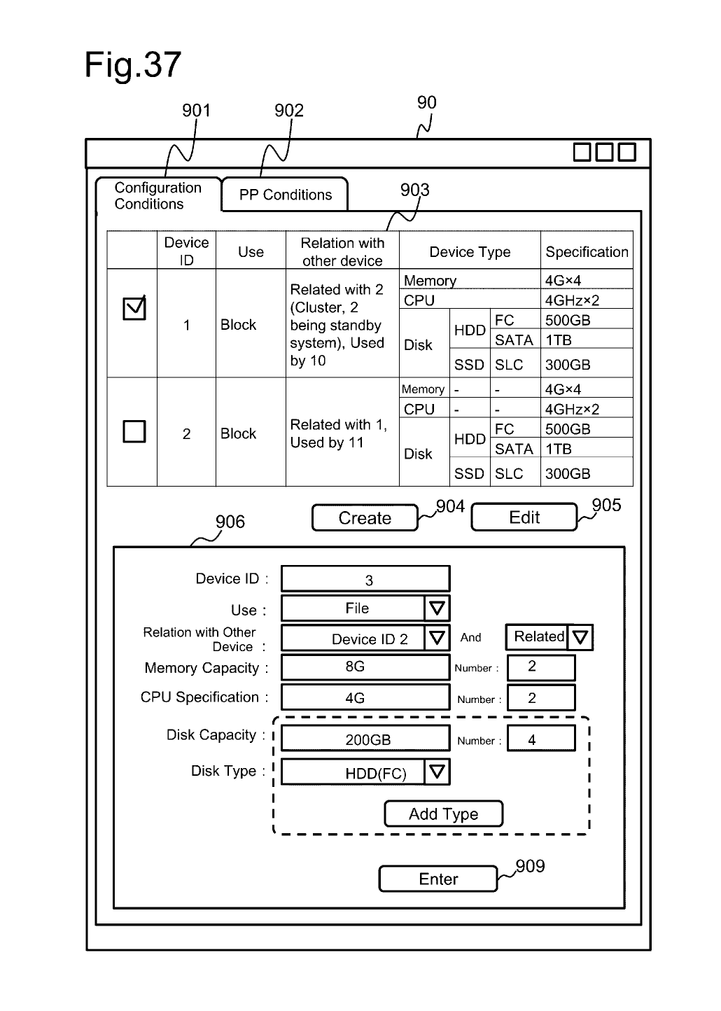

FIG. 37 illustrates an example of a screen 90 for entering user conditions displayed on the input and output device 505 of the management server 50. The screen 90 is composed of a screen 901 for entering the configuration conditions of the physical resources via the user, and a screen 902 for entering the conditions of the PP. The configuration conditions of physical resources by the user corresponds to the information in the migration source configuration management table of embodiment 1, and the conditions of PP by the user corresponds to the information in the migration source PP management table according to embodiment 1. In FIG. 37, the screen 901 and the screen 902 are illustrated as being switched via tabs, but the method is not restricted thereto, and the screens can be switched via arbitrary screen switching functions such as a toolbar, or the information in screens 901 and 902 can be simultaneously displayed in one screen.

FIG. 37 shows a state where the tab of the screen 901 is selected. The screen 901 is composed of a table 903 for displaying the configuration conditions entered by the user, a create button 904 for the user to enter new configuration conditions, an edit button 905 for the user to edit the entered data, and a screen 906 for entering or editing configuration conditions. The screen 906 is composed of various input boxes for setting conditions and an enter button 909 for fixing the entered information. In FIG. 37, the information to be entered by the user are the device ID, the purpose, the relation with other devices, the memory capacity, the number of memories, the CPU specification, the number of CPUs, the disk capacity, the disk type and the disk number, but not necessarily all these information must be entered by the user, and some of the information can be set by the management server.

The screen 902 also displays a screen through which the user can enter conditions similar to screen 901, but the detailed descriptions thereof are omitted since they are alike.

Next, the flowchart for entering conditions by the user are described.

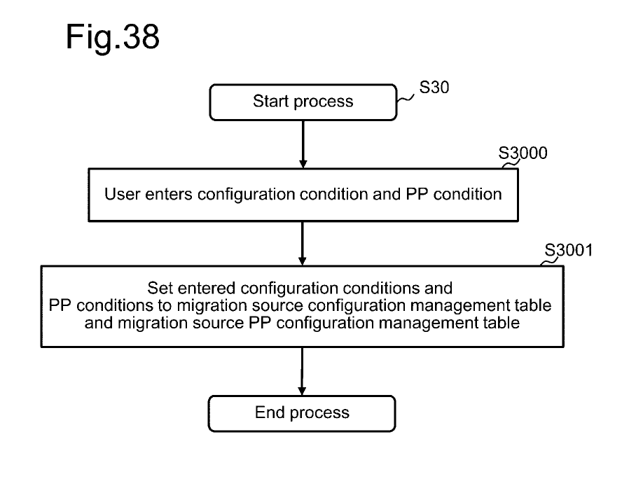

FIG. 38 is a drawing showing one example of the steps for the user to enter the configuration conditions and PP conditions. The respective steps will now be described.

(Step 3000) The user enters the configuration conditions and the PP conditions using the screen 90 within the input and output device 505 of the management server 50. FIG. 37 shows an example of newly creating configuration conditions. If configuration conditions are to be created newly, the configuration conditions can be set by clicking the create button 904, entering necessary items in the screen 906, and clicking the enter button 909. As for PP conditions, if the device ID is set during the setting of the configuration conditions, it is possible to set the conditions of the PP used in that device. Further, the conditions are not only created newly, but the conditions set by the user can be edited by the user by clicking the edit button 905.

(Step 3001) The management program 525 of the management server 50 sets the configuration conditions entered by the user in step 3000 to the migration source configuration management table 522 within the memory 502 of the management server. Further, the management program sets the PP condition entered by the user to the migration source PP management table 523 within the memory 502.

The fourth embodiment of the present invention has been described, but this embodiment is a mere example for better understanding of the present invention, and is not intended to limit the scope of the present invention in any way. The present invention can be realized in various other forms. For example, the configuration conditions and PP conditions can be entered using CLI, or the conditions can be set by reading the information entered in the setup file in advance by the management program 525.

The present embodiment 4 provides a computer system capable of proposing and determining a method for creating logical partitions and a method for setting storage configurations capable of maximizing the availability using limited resources within the new storage node by the user simply entering requirements, even if the computer system is not equipped with a migration source computer system, and to realize creation of virtual storage subsystems and virtual servers having a high availability.

### REFERENCE SIGNS LIST

1: Overall Computer System

10: Host Computer

20: File Storage

30: Block Storage

40: Storage Node

50: Management Server

1. A resource management system of a computer system comprising:
a host computer;
a storage subsystem having a memory device storing data being written or read by the host computer;
a storage node having a processor, a memory and a storage device as resources; and
a storage management computer capable of accessing the host computer, the storage subsystem and the storage node;
the storage management computer includes:
a storage means for retaining an amount of the resources capable of being used for creating a logical partition by virtually partitioning and allocating the resources that the storage node has, and a condition to be ensured for guaranteeing availability of the storage subsystem, the host computer and the logical partition; and
as a means to be utilized for executing system operation for creating or deleting the logical partition with respect to the storage node,
a computing means for specifying the logical partition and a storage configuration according to a possibility of sharing the resources among different logical partitions with an aim to maximize the number of conditions for enabling the conditions to be ensured within a range of amount of the resources; and
a presenting means for presenting the number of conditions for enabling the conditions to be ensured as an availability value together with a method for creating the logical partition and the storage configuration for maximizing the availability value.

2. The resource management system according to claim 1, wherein the presenting means presents a condition of insufficiency when the availability value is not 100%, and a method for solving the same.

3. The resource management system according to claim 1, further comprising
an input means for setting up a condition to be ensured for guaranteeing availability of the storage subsystem and the host computer.

4. The resource management system according to claim 1, wherein the type of the storage subsystem is at least either a block storage or a file storage.

5. The resource management system according to claim 1, wherein the computing means performs computation to maximize the number of conditions in response to a priority according to the purpose of use of the logical partition.

6. The resource management system according to claim 1, wherein if the logical partition is created as the system operation,
the computing means further computes the number of conditions to be ensured by the storage subsystem and the host computer based on a connection information of the storage subsystem and the host computer prior to migration.

7. The resource management system according to claim 1, wherein when one or more logical partitions are deleted from the storage node as the system operation,
the condition of the logical partition is set as the condition to be ensured.

8. The resource management system according to claim 1, wherein when system migration from the storage subsystem to the storage node is performed as system operation by adding one or more computer systems,
the condition of the logical partition is used as the condition to be ensured, and
the computation via the computing means targets all the resources of the migration source storage subsystem and the migration destination storage node.

9. The resource management system according to claim 8, wherein the storage management computer comprises
a saving means for saving the data in the logical partition of the storage node so as to execute a method for creating the logical partition and the storage configuration, and to return the saved data after creating the logical partition and the storage configuration.

10. The resource management system according to claim 3, wherein when a logical partition is newly created in the storage node as system operation,
the input means is used to set conditions to be ensured for securing availability of the storage node.

11. A resource management method of a computer system comprising:
a host computer;
a storage subsystem having a memory device for storing data written or read by the host computer;
a storage node having a processor, a memory and a storage device as resources; and
a storage management computer capable of accessing the host computer, the storage subsystem and the storage node;
wherein in order for the computer system to perform system migration from the storage subsystem to the storage node, as a system operation for creating or deleting a logical partition created by virtually partitioning and allocating the resources that the storage node has with respect to the storage node,
a first step of acquiring configuration information of the host computer and the storage subsystem;
a second step of generating a requirement for creating or deleting the logical partition from the configuration information;
a third step of specifying, based on a possibility of sharing resources among different logical partitions, the logical partition and the storage configuration capable of maximizing a number of conditions enabling conditions to be ensured for guaranteeing availability of the storage subsystem, the host computer and the logical partition within a range of amount of resources with respect to the generated requirement; and
setting a number of conditions enabling the conditions to be ensured as an availability value, a fourth step of presenting a method for creating the logical partition and the storage configuration and the availability value capable of maximizing said value.

12. The resource management method according to claim 11, wherein the third step further performs computation to maximize the number of conditions in response to a priority according to the purpose of use of the logical partitions.

13. The resource management method according to claim 11, wherein the fourth step further presents conditions of insufficiency and a method for solving the same when the value of the availability is not 100%.

14. The resource management method according to claim 11, further comprising
a step for entering conditions to be ensured so as to guarantee the availability of the storage subsystem and the host computer.

15. The resource management method according to claim 11, further comprising
a step of executing the method for creating the logical partition and the storage configuration after saving the data in the logical partition of the storage node, and returning the saved data after creating the logical partition and the storage configuration.
